(19) United States
(12) Patent Application Publication
(10) Pub. No.: US 2015/0149475 A1
(43) Pub. Date: May 28, 2015

(54) DATA HARMONIC ANALYSIS METHOD AND DATA ANALYSIS DEVICE

(71) Applicant: HITACHI, LTD., Tokyo (JP)

(72) Inventors: Kenji Nakahira, Tokyo (JP); Atsushi Miyamoto, Tokyo (JP)

(73) Assignee: HITACHI, LTD., Tokyo (JP)

(21) Appl. No.: 14/401,623

(22) PCT Filed: Jul. 5, 2013
(86) PCT No.: PCT/JP2013/068517

§ 371 Date: Nov. 17, 2014

(30) Foreign Application Priority Data
Aug. 30, 2012 (JP) 2012-189710

(51) Int. Cl. G06F 17/30

(52) U.S. Cl. CPC G06F 17/30958
USPC 707/741

(57) ABSTRACT

The present invention provides a data harmonic analysis method and a data analysis device for data analysis in which a plurality of data items to be analyzed are acquired; similarities among a plurality of data sources that generate the data values of the acquired plurality of data items are obtained; a hierarchical graph is generated as a graph structure indicating the acquired plurality of data items, with a plurality of child nodes corresponding to the plurality of data items being located in a lower layer and a parent node that has no data item being located in an upper layer; the connection rate between the parent node and each of the plurality of child nodes is calculated by using the information of the obtained similarities in the generated hierarchical graph; and harmonic analysis is applied, on the basis of the generated hierarchical graph, to the data values in the graph.

### BACKGROUND

The present invention relates to a method of analyzing data and its device, especially relates to a data harmonic analysis method suitable for analyzing complex data and a data analysis device used for it.

Harmonic analysis technique represented by Fourier analysis and wavelet analysis is used in many fields for a practical analysis method related to grid-like one-dimensional data and grid-like two-dimensional data. The grid-like data means uniform data in distance between adjacent data. When the harmonic analysis technique is used, various data analysis such as the estimate and forecasting of data, data compression, the removal of noise superimposed on data and the classification of data is made possible (for example, refer to S. G. Mallat, IEEE Trans. Pattern Anal. Machine Intell., vol. 11, No. 7, pp. 674-693, 1989). Recently, for a two-dimensional data analysis method, higher technique such as wedgelet and curvelet is also proposed (for example, refer to R. L. Claypoole and R. G. Baraniuk, Proc. SPIE, vol. 4119, pp. 253-262, 2000 and E. J. Candes, D. L. Donoho, IEEE Trans. Image Proc., vol. 11, pp. 670-684, 2002).

In the meantime, the importance of an analysis method also applicable to data which is not grid-like two- or less-dimensional data, that is, three- or more-dimensional data and data which is not arrayed in a grid (hereinafter called complex data) increases. If high-precision analysis technique for complex data can be established, the technique can be not only applied to the analysis of data acquired from a sensor network for example and the classification of data represented in complex feature space (for example, in non-Euclidean space) but the enhancement of the processing of conventional type grid-like two- or less dimensional data can be expected. However, a conventional type method developed to analyze grid-like two- or less-dimensional data is difficult to apply to complex data as it is.

Grid-like two- or less-dimensional data and complex data can be interpreted as data having graph structure. The graph structure means structure configured by a set of nodes (vertexes) and a set of edges that connect nodes. When two nodes are connected via one edge, the nodes are called connected. Gird-like two- or less-dimensional data can be regarded as data having two- or less-dimensional grid-like graph structure. To correspond to complex data, the development of harmonic analysis technique applicable not only to two- or less-dimensional grid-like graph structure but to data having more general graph structure is required. Though harmonic analysis methods applicable to data having these graph structures have been proposed, sufficient performance has been not acquired (for example, refer to U.S. Patent No. 2006/0004753 and M. Gavish, B. Nadler, R. R. Coifman, International Conference on Machine Learning, pp. 367-374, 2010).

### PATENT LITERATURES

U.S. Patent No. 2006/0004753

### Non-Patent Literatures

Non-patent literature 1: S. G. Mallat, IEEE Trans. Pattern Anal. Machine Intell., vol. 11, No. 7, pp. 674-693, 1989
Non-patent literature 2: R. L. Claypoole and R. G. Baraniuk, Proc. SPIE, vol. 4119, pp. 253-262, 2000
Non-patent literature 3: E. J. Candes, D. L. Donoho, IEEE Trans. Image Proc., vol. 11, pp. 670-684, 2002
Non-patent literature 4: M. Gavish, B. Nadler, R. R. Coifman, International Conference on Machine Learning, pp. 367-374, 2010

A main subject of harmonic analysis technique for data having graph structure is the compatibility of performance, computation and versatility. If an applied object is limited to simple graph structure, a harmonic analysis method in which high performance is acquired for data having the graph structure and computation is little may exist. For example, the above-mentioned wedgelet and curvelet are methods in which high-performance and high-speed harmonic analysis can be made for data having two-dimensional grid-like graph structure. However, it is difficult to apply these harmonic analysis methods to more general graph structure as they are. If the more general graph structure is approximated to two-dimensional grid-like graph structure, the application is enabled, however, the performance is deteriorated. Besides, for a method that can be applied to more general graph structure, harmonic analysis technique for data having tree structure is proposed (refer to M. Gavish, B. Nadler, R. R. Coifman, International Conference on Machine Learning, pp. 367-374, 2010). However, the tree structure is graph structure having a very strong constraint that only one node called an uppermost node and having no parent node exists and nodes except the node on an uppermost hierarchy have only one parent node and similarly, it is difficult to apply the harmonic analysis technique for data having tree structure to general complex data.

In the meantime, general purpose technique for arbitrary graph structure is proposed (refer to U.S. Patent No. 2006/0004753). However, though the technique is versatile, much computation is required and operation in an order of the square of the number of nodes Nv to the third power of Nv is generally required. Besides, the technique may be unable to fulfill sufficient performance for data having specific graph structure. For example, it is difficult to apply analysis utilizing the information of the hierarchical structure to data having hierarchical graph structure (that is, a graph in which nodes have membership).

The present invention settles the problems of the prior art and provides such a data harmonic analysis method and such a data analysis device that simultaneously meet performance, computation and versatility in the analysis of data having graph structure.

### SUMMARY

The present invention can be applied to graph structure in a sufficiently wide class though it cannot be applied to arbitrary graph structure and settles the problems by the following data harmonic analysis method and the following data analysis device as high-performance high-speed technique.

(1) The present invention is based upon a data harmonic analysis method including a data acquisition step for acquiring plural data pieces as objects of analysis, a similarity calculation step for calculating similarity between plural data sources which are sources of data values of the plural data pieces acquired in the data acquisition step, a hierarchical graph generation step for generating a hierarchical graph having a hierarchy of plural child nodes corresponding to the plural data pieces as a lower hierarchy and having a hierarchy of parent nodes having no data as an upper hierarchy as graph structure that represents the plural data pieces acquired in the data acquisition step, a connection rate calculation step for calculating a connection rate between each of the plural child nodes and its parent node in the hierarchical graph generated in the hierarchical graph generation step using the information of similarity acquired in the similarity calculation step and a harmonic analysis step for applying harmonic analysis to data values in the graph based upon the hierarchical graph generated in the hierarchical graph generation step for data analysis, and has a characteristic that harmonic analysis is carried our according to the connection rate calculated in the connection rate calculation step between the child node and the parent node in the analysis step.

In the present invention, harmonic analysis suitable for data in the form of a graph having hierarchical structure can be made. Tree structure is also one type of hierarchical graph structure, however, hierarchical graph structure which is an object in the present invention is not limited to the tree structure. That is, two or more nodes may also exist on an uppermost hierarchy and a node except the uppermost hierarchy may also have plural parent nodes. The hierarchical graph structure is graph structure in wide class including tree structure. Therefore, various data can be exactly represented. Harmonic analysis can be applied to a graph having tree structure by processing called orthogonal transformation, however, as non-orthogonal transformation is required in a hierarchical graph which is not tree structure, such a method for tree structure as in M. Gavish, B. Nadler, R. R. Coifman, International Conference on Machine Learning, pp. 367-374, 2010) cannot be applied. Besides, as a child node has plural parent nodes, harmonic analysis is required to be carried out in consideration of the strength of connection with respective parent nodes. In the present invention, harmonic analysis using non-orthogonal transformation is applied. Moreover, a connection rate between each child node and its parent node is calculated and a harmonic analysis method is changed according to the connection rate. In the meantime, the compatibility of performance and computation is enabled by making harmonic analysis positively utilizing information of the hierarchical structure of a graph differently from a general purpose method applicable to arbitrary graph structure. As for computation, high-speed operation is enabled by performing multi-resolution processing in which processing is applied to nodes on an upper hierarchy in order from nodes on a lowermost hierarchy.

(2) Besides, the present invention is based upon the hierarchical graph generation step and has a characteristic that a connection rate of each edge is calculated based upon the similarity and harmonic analysis is carried out based upon the connection rate.

In multiple hierarchical graphs, data structure can be more properly represented when a weighted graph in which a connection rate is assigned to each edge is considered. Similar data values can be strongly related by assigning a higher connection rate to the more similar data values.

(3) Moreover, the present invention is based upon the hierarchical graph generation step and has a characteristic that after the hierarchical graph is generated, the generated hierarchical graph is changed to a hierarchical graph in which all lowermost nodes have a data value, all nodes except the lowermost nodes have no data value and all nodes except an uppermost node have a parent node on an upper hierarchy by one.

As for data having hierarchical graph structure, the node having the data value and the node having no data value exist. Besides, a graph in which the child node is connected to the parent node on the upper hierarchy by two or more via an edge is also conceivable. As the hierarchical graph has multiple variations as described above, it is not easy to uniformly make harmonic analysis. Then, harmonic analysis can be applied to an arbitrary hierarchical graph by relatively simple processing by changing to a hierarchical graph for which processing is easy as preparation for the harmonic analysis.

(4) In addition, the present invention is based upon the harmonic analysis step and has a characteristic that when processing is performed using a node on an “n”th hierarchy from the lowermost hierarchy and a node on an (n+1)th hierarchy from the lowermost hierarchy in the hierarchical graph, processing for equalizing the total of the sum of squares of high resolution transformation coefficients and the sum of squares of the nodes on the (n+1)th hierarchy from the lowermost hierarchy to the sum of squares of data values of the nodes on the nth hierarchy from the lowermost hierarchy is performed.

In each of multi-resolution processing, the sum of squares of output (that is, the total of the sum of squares of the high resolution transformation coefficients and the sum of squares of the nodes on the (n+1)th hierarchy from the lowermost hierarchy) is equalized to the sum of squares of input (that is, the sum of squares of the data values of the nodes on the nth hierarchy from the lowermost hierarchy). Hereby, the sum of squares of the resolution transformation coefficients and the sum of squares of a data value of an uppermost node which are respectively the output of the harmonic analysis can be equalized to the sum of squares of data values of each node which are the input of the harmonic analysis. A property that the sum of squares of data values is kept before and after harmonic analysis is called Parseval's equality and harmonic analysis that meets this property is useful in data processing. For example, as the ratio of the sum of squares of noise included in data values which are input and the sum of squares of components (hereinafter called signal components) except noise is also stored after harmonic analysis, the quantity of noise can be easily estimated using its value after the harmonic analysis. In orthogonal transformation, it is guaranteed that the Parseval's equality is met, however, in non-orthogonal transformation, this equality is generally not met. However, in the present invention, processing that meets the Parseval's equality is also enabled in non-orthogonal transformation by performing processing for equalizing the sum of squares of the input to the sum of squares of the output in each of multi-resolution processing.

(5) Further, the present invention is based upon the harmonic analysis step and has a characteristic that high resolution transformation coefficients of a number equal to a value acquired by subtracting the number of all nodes from the sum of the number of edges in the hierarchical graph and the number of nodes having a data value are calculated.

In the case of tree structure, the number of all nodes is equal to a value acquired by adding 1 to the number of edges. Therefore, the sum of high resolution transformation coefficients and the number of a data value of an uppermost node (the latter is equal to 1) which are the output of harmonic analysis is equal to the number of nodes having a data value which are the input of the harmonic analysis. That is, the number in the output value and the number in the input value are coincident. In the meantime, in the present invention, graph structure that each node is connected to plural parent nodes can be also represented. At this time, natural processing having little computation is enabled by using harmonic analysis having the characteristic described in (4).

(6) Furthermore, the present invention is based upon the data harmonic analysis method and has a characteristic that data analysis is carried out by acquiring plural data pieces to be analyzed, calculating similarity between plural data sources which are generation sources of respective values of the acquired plural data pieces, specifying the number of nodes on an uppermost hierarchy out of one or more hierarchies of parent nodes having no data and arranged on the upside of a lowermost hierarchy as a hierarchy of plural child nodes corresponding to the plural data pieces in graph structure representing the acquired plural data pieces, generating a hierarchical graph including the lowermost hierarchy to the uppermost hierarchy on a condition of the specified number of nodes on the uppermost hierarchy, inputting information of a lower limit of the similarity for connecting each of the plural child nodes on the lowermost hierarchy in the generated hierarchical graph to its parent node on the upper hierarchy by one of the lowermost hierarchy, calculating a connection rate between each of the plural child node and its parent node using information of the calculated similarity and the input information of the lower limit of the similarity and applying harmonic analysis to the data values in the graph according to the calculated correction rate based upon the generated hierarchical graph.

As described above, the compression and the estimation of data values of complex data, the removal of noise and the classification of data can be performed at higher performance by utilizing the harmonic analysis method applicable to the hierarchical graph.

According to the present invention, data analysis can be carried out at high performance and at high speed by grasping complex data such as data acquired by plural and different types of sensors and multidimensional data as data having hierarchical graph structure and making harmonic analysis.

### BRIEF DESCRIPTION OF THE DRAWINGS

FIG. 1 shows a processing flow of a method of applying harmonic analysis to complex data;

FIG. 2A shows an example of complex data and shows images in a case that plural images are acquired and classified, FIG. 2B shows an image in an example in which noise removal processing is applied to the image, and FIG. 2C is a block diagram showing a sensor network as an example;

FIG. 3 is a block diagram showing the configuration of an analysis device that applies harmonic analysis to complex data;

FIG. 4A shows a flow of a process for calculating similarity between data sources, shows in detail a flow of the process for generating a group of multiple images different in the quantity of displacement, rotation and extension/reduction for one of two images in a case in which the data source is the image and acquiring similarity based upon a minimum value of finite difference between each image in the group and the other image, and FIG. 4B shows a flow of a process for calculating similarity between data sources, shows in detail a flow of the process for calculating respective feature values of two images in a case in which the data source is the image and acquiring similarity based upon the feature values acquired as a result of the calculation;

FIG. 5A shows a flow of a process for calculating similarity between data sources, shows in detail a flow of the process for extracting local areas including each of two pixels inside an image in a case in which the data source is a pixel in the image, calculating the sum of “p”th power of an absolute value of difference between the extracted local areas and acquiring similarity, and FIG. 5B shows a flow of a process for calculating similarity between data sources, shows in detail a flow of the process for extracting local areas including each of two pixels inside an image in a case in which the data source is the pixel in the image, differentiating the extracted respective local areas and acquiring finite difference, in the meantime, calculating feature values of the extracted respective local areas and acquiring similarity based upon finite difference between differential values acquired by the calculation and the feature values;

FIG. 6 shows a flow of a process for calculating similarity between data sources;

FIG. 7 shows examples of hierarchical graphs;

FIG. 8 shows an example of a hierarchical graph when a data source is an image;

FIG. 9A shows an example of a hierarchical graph when a data source is a pixel, shows in detail an image of the hierarchical graph showing an example that a way of connection is determined based upon similarity between nodes on upper and lower hierarchies in a state in which nodes acquired by thinning the number of nodes on a first hierarchy which is a lowermost hierarchy by ½ only in a direction shown by an arrow x are arranged on a second hierarchy and a node acquired by thinning the number of nodes on the second hierarchy by ½ only in the direction x is arranged on a third hierarchy which is an uppermost hierarchy, FIG. 9B shows an example of a hierarchical graph when a data source is a pixel, shows in detail an image of the hierarchical graph showing an example that a way of connection is determined based upon similarity between nodes on upper and lower hierarchies in a state in which nodes acquired by thinning the number of nodes on a first hierarchy which is a lowermost hierarchy respectively by ½ in directions x, y are arranged on a second hierarchy and nodes acquired by thinning the number of the nodes on the second hierarchy respectively by ½ in the directions x, y are arranged on a third hierarchy which is an uppermost hierarchy, and FIG. 9C shows an example of a hierarchical graph when a data source is a pixel, shows in detail an image of the hierarchical graph showing an example that two images are arranged on a first hierarchy which is a lowermost hierarchy, two groups of nodes are also arranged on second and third hierarchies and a way of connection is determined based upon similarity between nodes on upper and lower hierarchies;

FIG. 10 shows an example of a hierarchical graph when a data source is a sensor in a sensor network;

FIG. 11 shows an example that a hierarchical graph is reshaped when a condition that all lowermost nodes have a data value and conversely, nodes except a lowermost hierarchy have no data value or a condition that all nodes except nodes on an uppermost hierarchy have a parent node or parent nodes on an upper hierarchy by one is not met;

FIG. 12 is a flowchart showing a flow of a process for generating a hierarchical graph when a condition that all lowermost nodes have a data value and conversely, nodes except a lowermost hierarchy have no data value or a condition that all nodes except nodes on an uppermost hierarchy have a parent node or parent nodes on an upper hierarchy by one is not met;

FIG. 13A shows an example of a method of calculating a connection rate with a parent node when the sum of connection rates between each child node and its parent node is 1 and FIG. 13B shows an example of a state of connection with a parent node when no constraint that the sum of connection rates between each child node and its parent node is 1 exists;

FIG. 14 is a flowchart showing a flow of processing in a method of making a multi-resolution harmonic analysis;

FIG. 15 is a flowchart showing a flow of processing in a method of performing inverse transformation of the multi-resolution harmonic analysis;

FIG. 16 shows an example in which harmonic analysis is carried out so that the total of the sum of squares of a high resolution transformation coefficient and the sum of squares of data values of uppermost nodes is equal to the sum of squares of data values of each node before a harmonic analysis step is executed;

FIG. 17 shows an example in which high resolution transformation coefficients of a number equal to a value acquired by subtracting the number of all nodes from the sum of the number of edges in a hierarchical graph and the number of nodes having a data value are calculated in the harmonic analysis step;

FIG. 18 is a flowchart showing a flow of a process for removing noise using harmonic analysis applied to complex data;

FIG. 19 shows a method of a degeneration process in S1810 in the flowchart shown in FIG. 18;

FIG. 20 is a flowchart showing a flow of a process for estimating data using harmonic analysis applied to complex data;

FIG. 21 is a flowchart showing a flow of a process for dynamically performing half teaching type data classification, sequentially acquiring data; and

FIG. 22 shows a user interface screen when harmonic analysis is applied to complex data.

### DESCRIPTION OF THE PREFERRED EMBODIMENTS

The present invention relates to a method of analyzing complex data such as data acquired by plural different sensors and multidimensional data, especially provides a method of regarding data as data having hierarchical structure and making harmonic analysis and its device. Referring to the drawings, embodiments of the present invention will be described below.

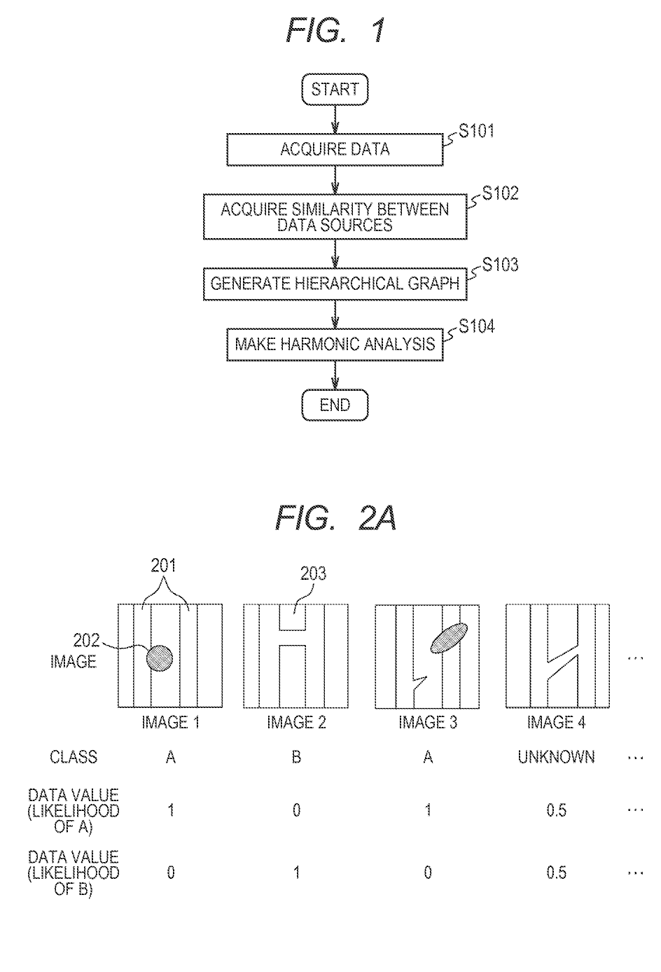

FIG. 1 is a flowchart of an embodiment which shows a method of applying harmonic analysis to complex data. This flow includes a step S101 for acquiring data, a step S102 for acquiring or calculating similarity between data sources based upon the acquired data, a step S103 for generating a hierarchical graph and a step S104 for applying harmonic analysis to data values using the generated hierarchical graph. The data means various information to be processed including a value (hereinafter called a data value) to be analyzed by harmonic analysis and information related to a source (hereinafter called a data source) that generates the data value. The data may also include information which cannot be directly observed. In the step S103, a hierarchical graph which is not tree structure is generated and in the step S104, harmonic analysis is carried out using the hierarchical graph. A concrete harmonic analysis method will be described later.

As described above, high-performance analysis can be applied to various data which can be represented by a hierarchical graph by generating a hierarchical graph which is not tree structure and making harmonic analysis suitable for data on the hierarchical graph. Besides, multi-resolution processing can be performed by performing processing of a node on a hierarchy on the upside sequentially from a lowermost node and hereby, computation can be reduced.

The details of each step will be described showing concrete examples below.

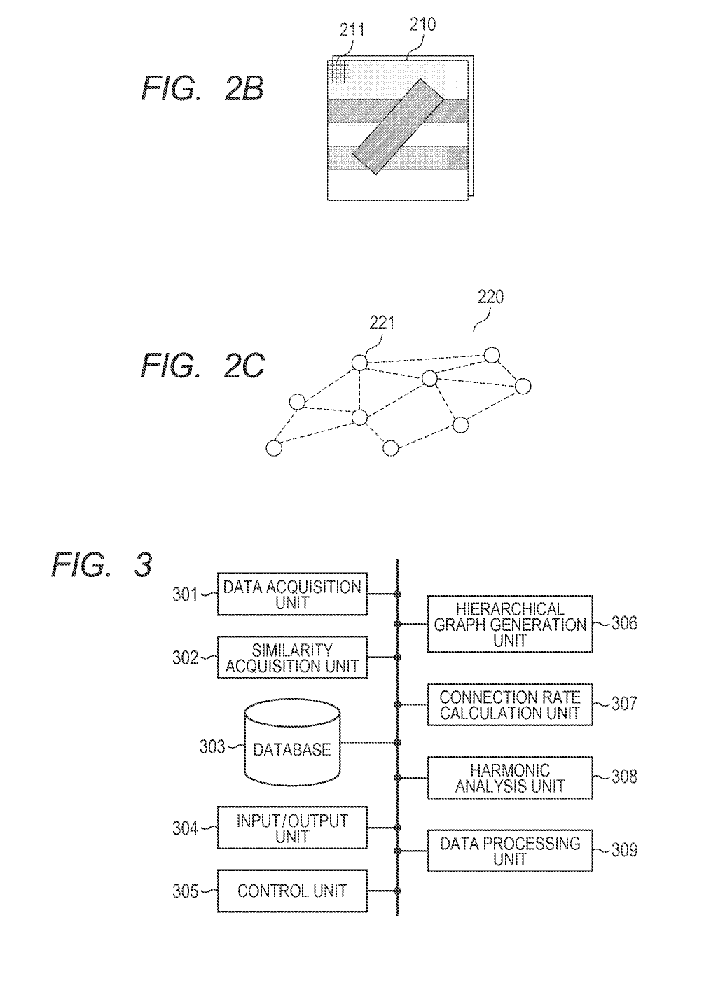

First, examples of data will be described referring to FIGS. 2A to 2C. FIG. 2A shows the example in which plural images are acquired and the images are classified. An image 1 includes two linear structures 201 and circular structure 202. An image 3 is also similar. An image 2 includes only linear structure 203, however, its topology is different from that in the image 1 and two linear structures are connected. Linear structure in an image 4 has the same topology as the structure 203. Suppose that these images are classified, for example, the images (the images 1, 3) having the circular structure are classified into Class A and the images (the images 2, 4) having structure of the same topology as the structure 203 are classified into Class B. As for a part of images, it is known beforehand to which class they belong, however, as to remaining images, it is unknown to which class they belong. In this case, the images and information related to the class to which each image belongs are data.

Besides, an image can be classified by applying harmonic analysis to a value representing a class. For example, suppose that a numeric value acquired by representing a degree as Class A by a real value 0 to 1 is a data value. Each image is a data source. In this case, each data value of the image 1 and the image 3 is 1 and a data value of the image 2 is 0. As it is unknown to which class the image 4 belongs, its data value shall be 0.5 between 0 and 1. It can be regarded that a problem of the classification of an image lies in estimating a data value of an image the class of which is unknown. A data value is not required to be a scalar and may be also a vector. For example, suppose that each image is classified into three classes of Class A, B, C. In this case, a data value can be represented as a vector value configured by three real numbers showing a degree of any of Class A, B, C. Moreover, a data value is not a scalar or a vector of a real number but may be also a scalar or a vector of a complex number, a quaternion and others.

FIG. 2B shows an example in which noise is removed from one or more images 210. The image is configured by multiple pixels such as 211. In this case, it can be regarded that the image is data, each pixel is a data source and a luminance value of each pixel is a data value. In the case of a color image, a luminance value can be represented as a vector. FIG. 2C shows an example of the configuration of a sensor network 220. A sensor is represented by a circle the inside of which is white. Besides, FIG. 2C shows that the sensors tied by a broken line are mutually communicable. When analysis is applied to the output of each sensor, each sensor 221 is a data source, the output (for example, temperature) of each sensor is a data value, and the data value and various information of sensors (for example, a position and a state of each sensor) are data.

FIG. 3 is a block diagram showing one embodiment of an analysis device that applies harmonic analysis to complex data. This device is configured by a data acquisition unit 301 that acquires data to be analyzed, a similarity acquisition unit 302 that acquires or calculates similarity between data sources, a hierarchical graph generation unit 306 that generates a such hierarchical graph that at least one node having plural parent nodes exists as graph structure representing data based upon similarity, a connection rate calculation unit 307 that calculates a connection rate between each child node and the parent node in the hierarchical graph and a harmonic analysis unit 308 that applies harmonic analysis to a data value of the graph based upon the hierarchical graph. Furthermore, this device is provided with a database 303 for storing data, an input/output unit 304 that inputs/outputs data and various parameters in analysis, a control unit 305 that controls each processing and a data processing unit 309 that estimates and forecasts data, compresses data, remove noise superimposed on data and classifies data.

High-performance analysis can be applied to complex data by generating the hierarchical graph which is not tree structure and making harmonic analysis suitable for data on the hierarchical graph using this device.

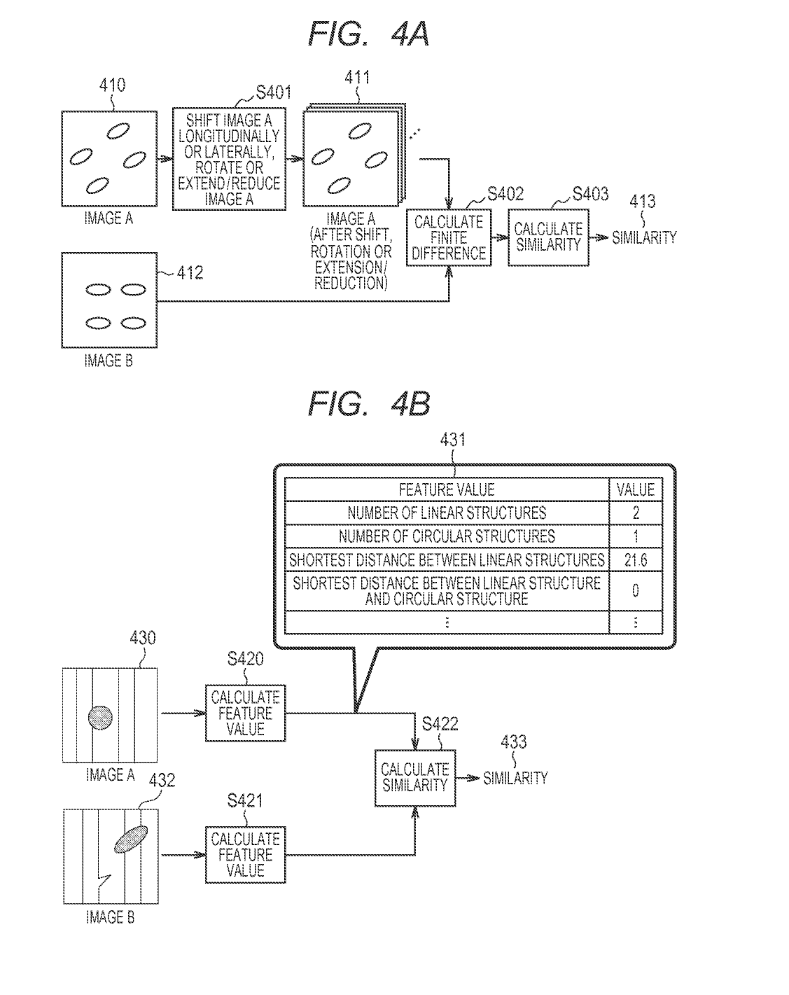

Next, a method of calculating similarity between data sources will be described referring to FIGS. 4 to 6. FIGS. 4A and 4B show one embodiment showing a flow of a process for calculating similarity between data sources. FIGS. 4A and 4B show a case that the data source is an image as an example. In FIG. 4A, to calculate similarity between two images, first, processing such as a longitudinal shift, a lateral shift, rotation and extension/reduction is applied to an image A 410 in a step S401 and a group of images 411 including multiple images different in the quantity of displacement, rotation and extension/reduction is generated. Next, in a step S402, difference between the group of images 411 and an image B 412 is calculated. This difference can be calculated by adding absolute values of luminance values of pixels in the same position for example, however, another calculation method may be also adopted (for example, the sum is not the simple sum but may be also the weighted sum acquired by adding a weight according to a certain criterion and may be also the sum of squares).

Finally, in a step S403, similarity 413 is acquired from a minimum value of differences calculated for each image in the group of images 411. When the minimum value of the difference is dₘᵢₙ, similarity s is acquired by “s=exp(−k×dₘᵢₙ)” for example, however, the present invention is not limited to this (k: constant). Even if the image A is shifted/rotated/extended/reduced for the image B, similarity can be acquired without being effected by the shift/rotation/extension/reduction by this method. Similarity between arbitrary two images is calculated according to this method.

In FIG. 4B, similarity is calculated according to a method different from the method shown in FIG. 4A. This example will be described using the images shown in FIG. 2A. First, in steps S420, S421, feature values of two images A, B of 430, 432 are calculated. The feature value 431 includes a set of the image and featuring values such as the number of linear structures included in the image, the number of circular structures, the shortest distance between the linear structures and the shortest distance between the linear structure and the circular structure. Next, in a step S422, similarity 433 is calculated using the feature values. As for the calculation of the similarity, a method of calculating the weighted sum of an absolute value of difference between each item and calculating similarity based upon the sum can be utilized for example and another method may be also adopted. In the calculation method shown in FIG. 4B, an item (for example, the size of the circular structure and others) which is not important in judging whether images are similar or not can be made to hardly have an effect in calculating important items that feature the image as feature values.

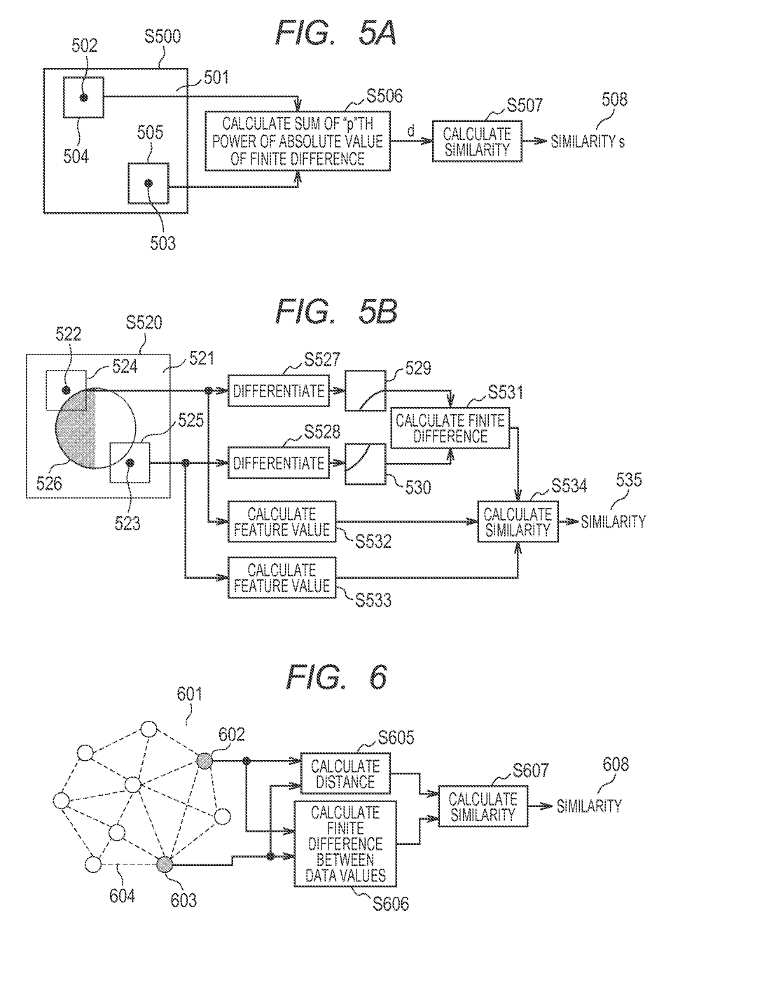

FIG. 5 shows a flow of a process for calculating similarity between data sources and shows one embodiment separate from the embodiment shown in FIGS. 4A, 4B. FIGS. 5A and 5B show an example of a case that data sources are pixels in images. In FIG. 5A, similarity between two pixels 502, 503 inside an image 501 is calculated. First, a local area 504 having the pixel 502 in the center is extracted in a step S500. Similarly, a local area 505 having the pixel 503 in the center is extracted. Next, the sum of the “p”th power of an absolute value of difference between the two local areas 504, 504 is calculated in a step S506 (p: constant). In a step S507, similarity “s” in 508 is calculated using output d in the step S506. The similarity s is acquired according to “s=k/(d+1)” for example, however, the present invention is not limited to this (k: constant). The similarity between each pixel can be calculated using information in the vicinity of it by such a process. Therefore, when an image is a picture including a person's face for example, such calculation that similarity between pixels in a flat area inside the face is increased with flesh color and similarity between a pixel in the above area and a pixel in an area of hair is reduced can be made.

In FIG. 5B, similarity is calculated by a more complex calculation method than the method shown in FIG. 5A. In this example, similarity between two pixels 522, 523 inside an image 521 is calculated. First, in a step S520, a local area 524 having the pixel 522 in the center and a local area 525 having the pixel 523 in the center are extracted. In these areas, a part of a circle 526 is included. The color of the circle included in the area 524 and the luminance of the circle included in the area 525 are different, however, the effect of the luminance of the circle shall be not considered in the calculation of similarity. In steps S527, S528, the local areas 524, 525 are differentiated. Afterward, in the step S531, finite difference between images 529, 530 which are output in the steps S527, S528 is calculated. The effect of the luminance of the circle can be softened by calculating the difference between the differentiations. Besides, in steps S532, S533, feature values of the local areas 524, 525 are calculated. The feature values mean a set of values that feature an image as described referring to FIGS. 4A, 4B.

Finally, similarity 535 is calculated in a step S534 using the finite difference calculated in the step S531 and the feature values calculated in the steps S532, S533. In this example, similarity is calculated using only the finite difference between the differentiations and the feature values, however, more information such as finite difference between the second-order differentials may be also used. As in the case shown in FIG. 4B, a suitable method has only to be properly selected as a calculation method of similarity so that similarity can be calculated more in consideration of the following criterion in the case of a more important criterion as a criterion for judgment of similarity. In FIGS. 5A, 5B, the examples using the two-dimensional images are shown, however, even if each point that configures a one-dimensional data array and a three- or more-dimensional data array is a data source, similarity can be calculated by the similar method.

FIG. 6 shows a flow of a process for calculating similarity between data sources and shows one embodiment separate from the embodiments described referring to FIGS. 4, 5. In FIG. 6, an example in which data acquired from a sensor network is analyzed is shown and the data source is a sensor. In this example, similarity between two sensors 602, 603 included in the sensor network 601 is calculated. First, in a step S605, distance between the sensors is calculated. This distance may be also spatial Euclidean distance between the sensors and for another criterion, a calculation method in which distance shall be 0 (zero) when the sensors can be mutually communicated (corresponding to a case that the sensors are tied by a broken line in FIG. 6) and distance shall be 1 when they cannot be mutually communicated may be also adopted. The distance is not required to meet a mathematical axiom of distance. Besides, in a step S606, finite difference in a data value acquired from each sensor is calculated. When a data value is acquired every fixed sampling time, finite difference with a mean value of the data values may be also calculated. Next, in a step S607, similarity 608 is calculated based upon finite difference in the distance and the data value. Hereby, the similarity between the sensors can be calculated.

In FIGS. 4 to 6, the examples of the method of calculating similarity are shown, however, the present invention is not limited to these calculation methods. For example, in some cases, similarity can be acquired together with another information of data depending upon an application and the definition of similarity. In that case, the acquired similarity may be used and the calculation of similarity is not required.

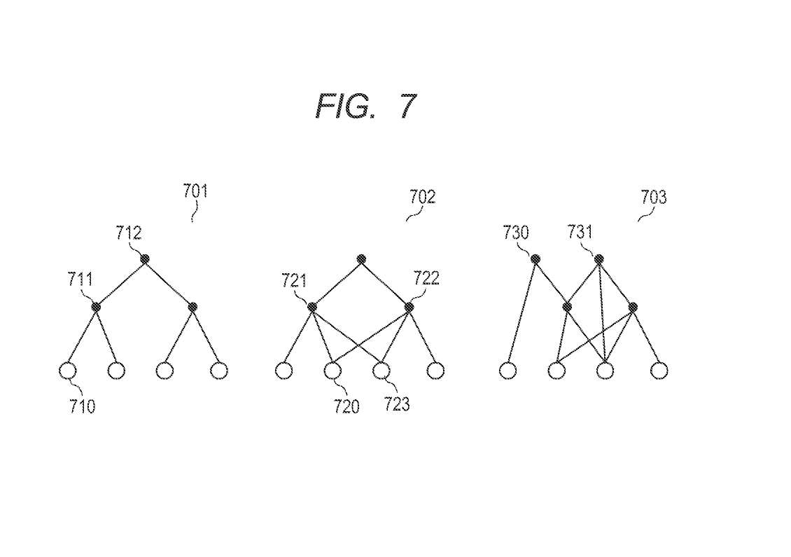

Next, a method of generating a hierarchical graph will be described referring to FIGS. 7 to 10. First, the hierarchical graph will be described using FIG. 7. A graph 701 is a graph called a tree which is one type of the hierarchical graph. A white circle denotes a node having a data value and one node corresponds to a data source. A black circle denotes a node having no data value. Nodes on the upside in FIG. 7 show that they are located on an upper layer. When two nodes are connected via an edge, one node is not located on the same layer as the other node and is necessarily located on an upper or lower layer. For example, a node 710 is connected to a node 711 on a layer on the upside via an edge. In this case, the node 711 is called a parent node of the node 710 and the node 710 is called a child node of the node 711. A node 712 is the top node. The tree means the hierarchical graph which has only one top node and in which all nodes except the top node have one parent node. A harmonic analysis method is proposed for data having tree structure as described above.

Graphs 702, 702 are examples of hierarchical graphs which are not a tree. In the graph 702, a node 720 has two parent nodes 721, 722. A node 723 is also similar. In the graph 703, a node having two or more parent nodes exists and in addition, the node further has the two top nodes 730, 731. As described above, the hierarchical graphs 702, 703 do not meet the requirements of a tree. Complex data structure can be represented by considering the hierarchical graphs not limited to the tree.

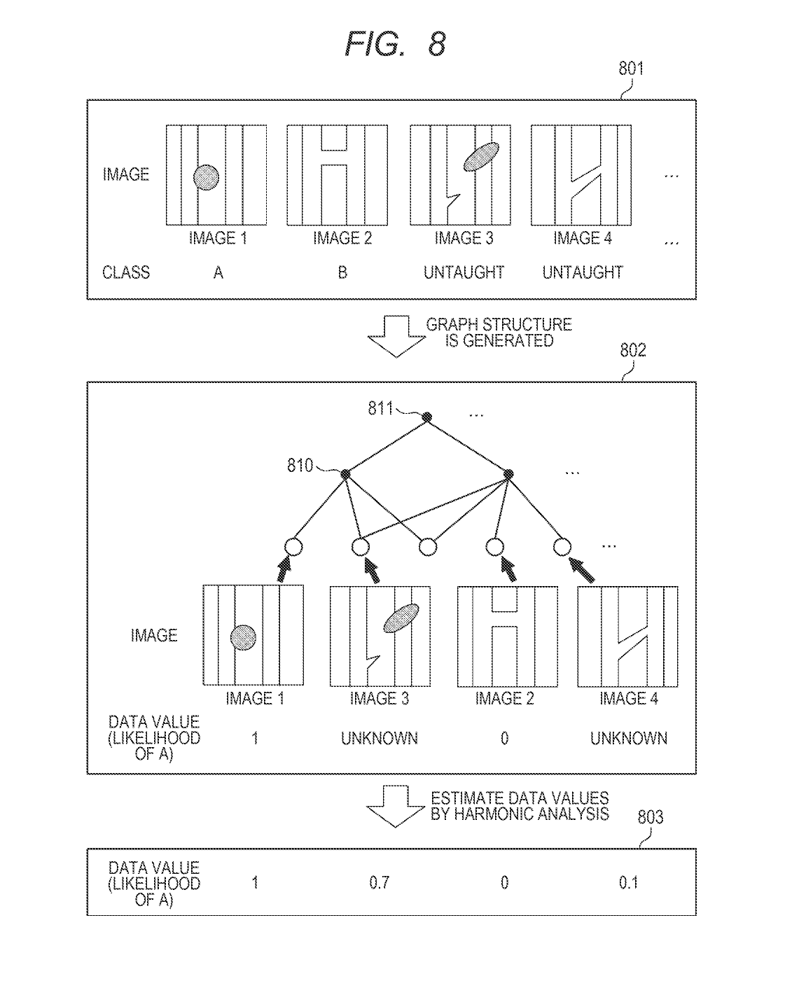

Next, an example of a generated hierarchical graph will be described. FIG. 8 shows one embodiment of the hierarchical graph when a data source is an image. Data 801 is the data for classifying the images described referring to FIG. 2A. A reference numeral 802 denotes an example in which a hierarchical graph is generated based upon this data. Each of the lowermost nodes corresponds to an image which is a data source. Accordingly, each lowermost node has a data value. At this time, such a graph that more similar images are arranged closer is generated. In this case, the close arrangement means that the lowermost nodes have common parent node as lower as possible on a layer when parent nodes are followed. For example, similarity between the images 1, 3 is higher than similarity between the images 1, 2. In the graph, as a node 810 at a second stage from the lowermost is a common parent node for the image 1 and the image 3, and a node 811 at a third stage from the lowermost is a common parent node for the image 1 and the image 2. Therefore, the image 1 and the image 3 are arranged closer than the image 1 and the image 2.

This is an example in which semi-teaching type image classification is applied in which each image belongs to either of Class A or Class B. And in this case, it is taught that the image 1 belongs to Class A and the image 2 belongs to Class B, however, the image 3 and the image 4 are untaught. A data value that represents likelihood of Class A is defined and, in this case, data values of the image 1 and the image 2 are set as 1 and 0 respectively. Data values of the images 3, 4 are estimated by applying harmonic analysis, described later, to the above data values. As shown in a reference numeral 803, supposed results of estimating the data values of the image 3 and the image 4 are set as 0.7 and 0.1. When the data values are equal to or exceeding a certain value (for example, 0.5), the image is classified into Class A and if not, the image is classified into Class B. In this example, the image 3 is classified into Class A and the image 4 is classified into Class B.

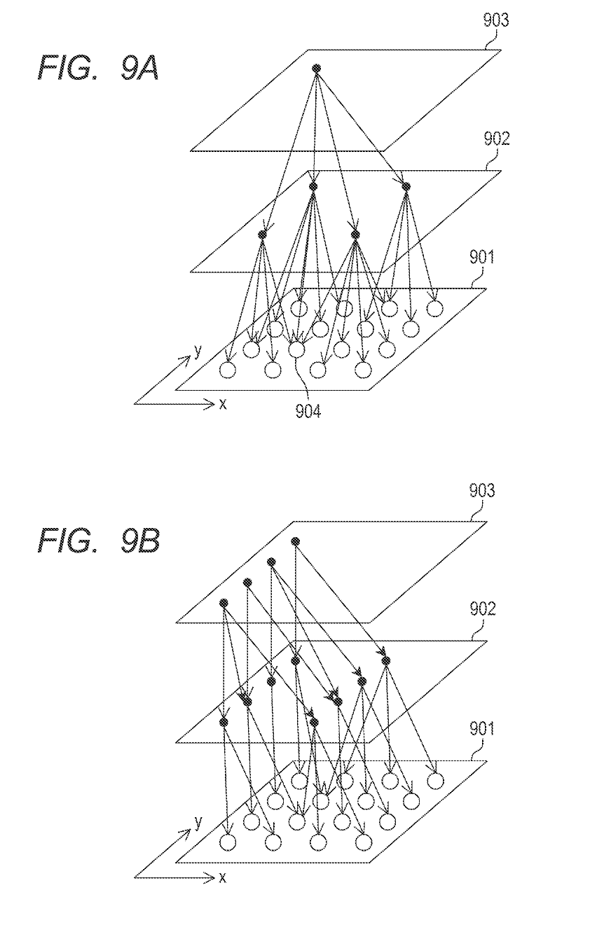

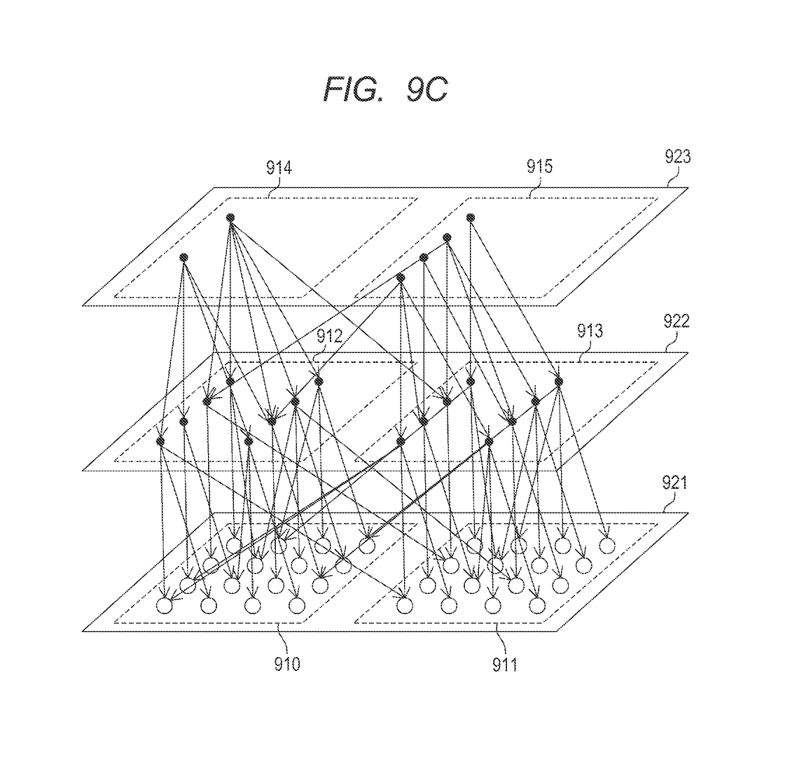

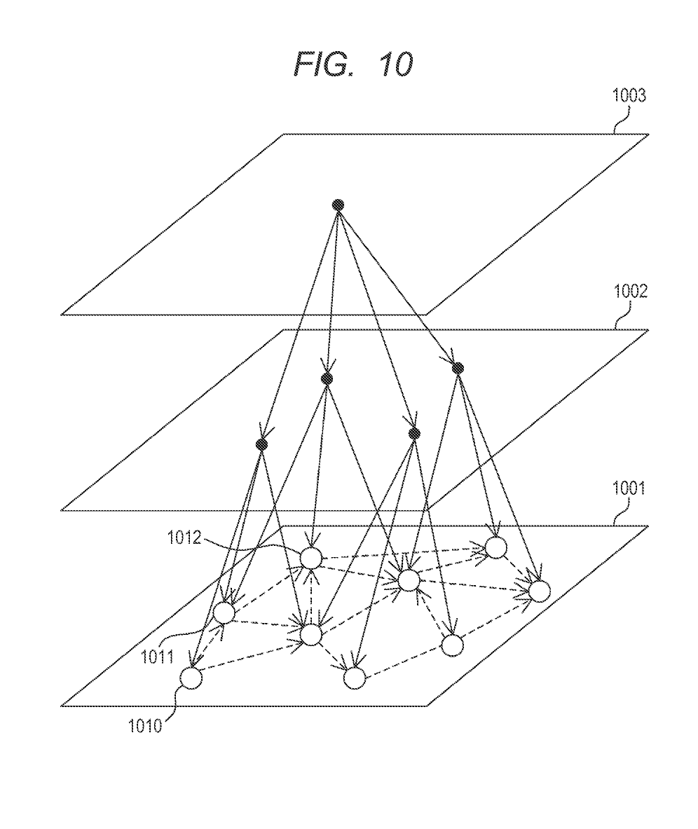

FIGS. 9A, 9B, 9C show one embodiment of a hierarchical graph when a data source is a pixel. FIGS. 9A, 9B show examples of images each of which is made of 16 pixels and different hierarchical graphs having each pixel as nodes on a lowermost layer are generated. The graphs are stereoscopically drawn and layers 901, 902, 903 denote first, second and third layers from the downside. Sixteen nodes exist on the lowermost layer 901. In FIG. 9A, 4 nodes exist on the second layer 902 from the downside and the nodes are thinned compared with the lowermost nodes in directions shown by arrows x, y of the image both by ½. On top layer 903, one node exists and the nodes are thinned compared with the nodes in the second layer in the directions shown by the arrows x, y of the image further by ½. An edge is represented by an arrow directed from a parent node to a child node. The nodes on the lowermost layer located in the same position are correlated to the node on the second layer from the downside and a way of connection is determined based upon similarity between the nodes. The hierarchical graph is generated so that the similar pixels have the common parent node on the second layer from the downside.

When plural similar nodes of parent nodes exist, the child node may have the plural parent nodes. For example, the node 904 has three parent nodes. In FIG. 9B, a second layer 902 from the downside includes 8 nodes and the nodes are thinned only in a direction shown by an arrow x of the image by ½. The top layer 903 includes 4 nodes and the nodes are further thinned compared with the second layer 902 only in the direction shown by the arrow x of the image by ½. FIG. 9A has an advantage that isotropic processing can be performed in the directions x, y, however, resolution is deteriorated both in the directions x, y on the upper layer. FIG. 9B has an advantage that resolution in the direction y is hardly deteriorated. A graph may be generated according to a purpose.

FIG. 9C shows an example of two images each of which includes 16 pixels and different hierarchical graphs of the two images having each pixel as a lowermost node are generated. Layers 921, 922, 923 are equivalent to first, second third layers from the downside. The layer 921 includes a group of nodes 910 corresponding to pixels of one image and a group of nodes 911 corresponding to pixels of the other image. Compared with the method of generating each graph shown in FIGS. 9A, 9B for each of the two images, further proper analysis can be expected when the images are related in the example shown in FIG. 9C. In this example, the group of nodes 910 corresponding to pixels of one image is connected to a group of nodes 912 and a group of nodes 914 as nodes on upper layers and the group of nodes 911 is connected to a group of nodes 913 and a group of nodes 915 as nodes on upper layers. Further, nodes having strong relevance to another image in the groups of nodes 910, 911 are connected to each group of nodes 913, 912. Similarly, some nodes out of nodes in the groups 912, 913 are connected to nodes in the groups 915, 914. The graph is not required to be symmetrical with the images and for example, as in the group of nodes 914 and the group of nodes 915, the number of nodes may be also different. For example, when the resolution of the image shown by the group of nodes 910 is lower than that of the image shown by the group of nodes 911, computation required for analysis can be reduced without deteriorating analysis performance by relatively reducing the number of nodes in the group 914.

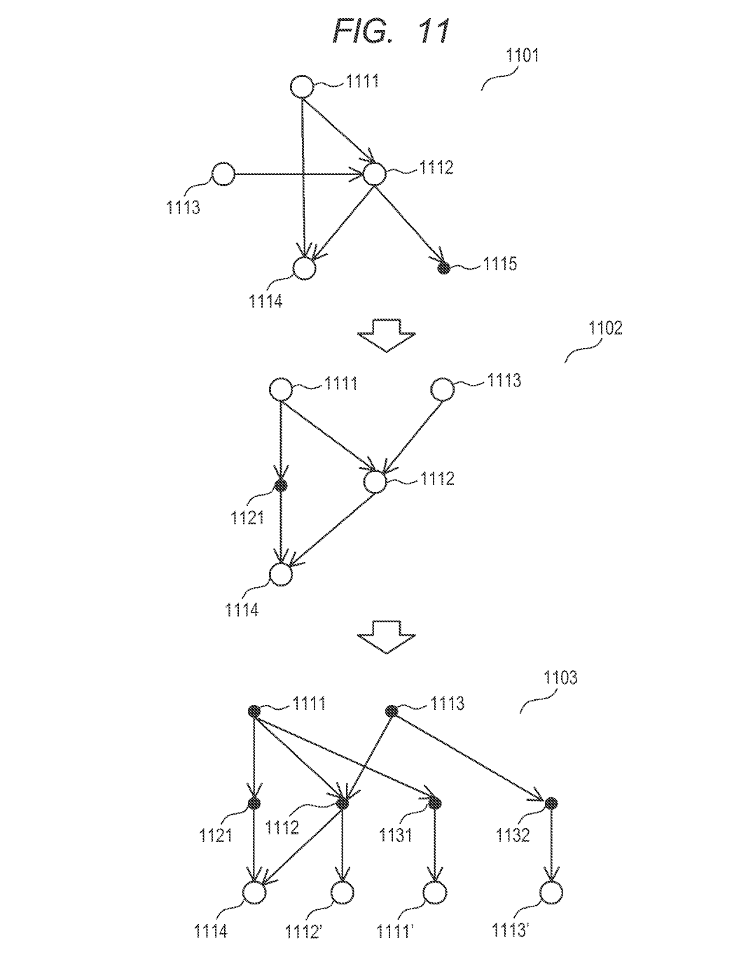

FIG. 10 shows an example of a sensor network and shows one embodiment of a hierarchical graph when a data source is a sensor. FIG. 10 is stereoscopically drawn as in FIGS. 9A, 9B, 9C and layers 1001, 1002, 1003 denote first, second and third layers from the downside. On a lowermost layer 1001, nodes corresponding to all sensors exist. On the second layer 1002 from the downside, four nodes having no data value exist and on an uppermost layer 1003, one node having no data value exists. A hierarchical graph is generated so that similar sensors have a common parent node on the second layer from the downside. When plural similar parent nodes exist, the child node may have plural parent nodes.

As shown in FIGS. 8 to 10, relation between data sources can be precisely represented by generating the hierarchical graph which is not a tree based upon various data. The enhancement of analysis performance can be expected by performing data analysis using such a hierarchical graph. For example, in FIG. 10, suppose that a node 1010 and a node 1011 are similar and the node 1011 and a node 1012 are similar, however, the node 1010 and the node 1012 are not similar so much. Therefore, such a graph that a pair of the node 1010 and the node 1011 and a pair of the node 1011 and the node 1012 have each common parent node and a pair of the node 1010 and the node 1012 has no common parent node is generated. In this embodiment, such a hierarchical graph such as the graph shown in FIG. 10 can be generated. In the meantime, when a hierarchical graph is limited to a tree, such a graph cannot be generated.

In all the graphs shown in FIGS. 8 to 10, all the lowermost nodes have a data value and conversely, the nodes except those on the lowermost layer have no data value. Besides, all the nodes except the nodes on the uppermost layer have the parent node on the layer on the upside by one. In harmonic analysis described later for the hierarchical graph, suppose that these conditions are met before the harmonic analysis. Next, it will be described referring to FIG. 11 that a hierarchical graph that does not meet these conditions can be changed to a graph that meets these conditions.

In a graph 1101, nodes 1114, 1115 are nodes on a lowermost layer, however, the node 1115 has no data value. Besides, nodes 1111 to 1113 which are not lowermost have a data value. Further, as the node 1112 is a parent node of the nodes 1114, 1115, it is grasped that the node 1112 is located on a second layer from the downside and as the node 1111 is a parent node of the node 1112, it is grasped that the node 1111 is located on a third layer from the downside. Then, the node 1114 has the parent node 1111 on the upside by two layers.

In a graph 1102, the graph 1101 is coordinated to facilitate the understanding of the hierarchies, a node 1121 is added, and further, the lowermost node 1115 having no data value is deleted. It is known that a condition that all the nodes except the uppermost node have the parent node on the layer on the upside by one by adding the node 1121 having no node value is met. Besides, as the lowermost node having no data value has no effect on the analysis of a data value, the node may be also deleted.

In a graph 1103, in place of replacing the nodes 1111 to 1113 having a data value of the nodes except those on the lowermost layer with nodes having no data value, nodes on a lowermost layer having the same data value are newly added and each node is connected via an edge. Nodes 1111′ to 1113′ are nodes on a lowermost layer added in place of the nodes 1111 to 1113. As the nodes 1111, 1113 are nodes on a third layer from the downside, nodes 1131, 1132 on a second layer from the downside are added. When a harmonic analysis method described later is used, it is considered that such shift of a data value has no effect. The graph can be converted to a graph that meets the above-mentioned conditions by such a change. When harmonic analysis is applied to the data having such graph structure, the nodes except those on the lowermost layer are also made to have a data value as descried later.

In data having hierarchical graph structure, the node having a data value and the node having no data value exist. Besides, a graph in which a child node is connected to a parent node on a layer on the upside by two or more via an edge is also conceivable. As the hierarchical graph has multiple variations as described above, it is not easy to uniformly apply harmonic analysis. Then, harmonic analysis can be applied to an arbitrary hierarchical graph by relatively simple processing by changing the current hierarchical graph to a hierarchical graph easy to process as preparation for the harmonic analysis.

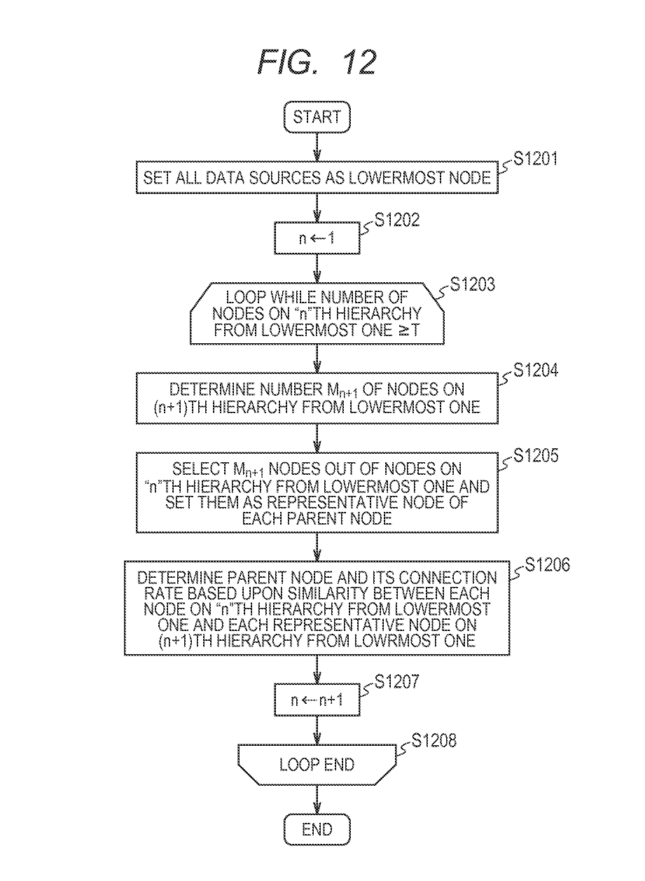

FIG. 12 is a flow of an embodiment which shows a process for generating a hierarchical graph. First, in a step S1201, all data sources are set as nodes on a lowermost layer. Next, in a step S1202, “n” is replaced with 1. Next, as long as the number of nodes located on an “n”th layer from the lowermost layer is T or more, steps S1203 to 1208 are executed. When the number of the nodes located on the nth layer from the lowermost layer is below T, the process is finished. In the step S1204, the number Mₙ₊₁ of nodes on an (n+1)th layer from the lowermost layer is determined. In the step S1205, Mₙ₊₁ pieces of nodes are selected out of the nodes located on the nth layer from the lowermost layer and the selected nodes are used for representative nodes of the nodes on the (n+1)th layer from the lowermost layer. Besides, the node on the (n+1)th layer from the lowermost layer corresponding to each of the selected Mₙ₊₁ pieces of nodes are set as a parent node. In a step S1206, a parent node and its connection rate are determined based upon similarity between each node on the nth layer from the lowermost layer and each node on the (n+1)th layer from the lowermost layer. In a step S1207, a value of n is incremented by 1.

In the step S1204, the number Mₙ₊₁ of nodes may be also fixed beforehand and may be also changed according to data. For example, in FIG. 9, the number of nodes is fixed beforehand, however, the number is not required to be fixed. Mₙ₊₁ may be also calculated based upon the number Mₙ of nodes on the nth layer from the lowermost layer for example and may be also calculated using similarity between the nodes on the nth layer from the lowermost layer and another information.

Besides, when the Mₙ₊₁ pieces of nodes are selected as representative nodes of the nodes on the (n+1)th layer from the lowermost layer in the step S1205, it is desirable that the representative nodes are not biased. As a node that does not belong to the following classes cannot be connected to the similar node when the representative nodes are occupied by only a few types of specific classes in generating a hierarchical graph for data for image recognition for example, it is desirable that the representative nodes are occupied by multiple types of classes. Then, Mₙ₊₁ pieces of nodes are selected out of the nodes on the nth layer from the lowermost layer so that mutual similarity is low. Hereby, the representative nodes can be made unbiased.

Moreover, when the representative nodes are selected in the step S1205, plural nodes (for example, nodes v₁, v₂) on the nth layer from the lowermost layer may be also made to correspond to a representative node (for example, a node u) of one node on the (n+1)th layer from the lowermost layer in place of correlating one node on the nth layer from the lowermost layer to a representative node of one node on the (n+1)th layer from the lowermost layer. In this case, similarity between a node v located on the nth layer from the lowermost layer and the representative node u can be defined using similarity between v and v₁ and similarity between v and v₂.

Referring to FIG. 12, the one embodiment of the method of generating the hierarchical graph is described, however, a hierarchical graph may be also generated using another method. In addition, when data is changed every time (that is, when time series data is handled), a hierarchical graph may be also changed every time. Similarly, when data sources correspond to three types of sensors for example, plural types of hierarchical graphs may be also generated such as three hierarchical graphs are generated every information acquired from each sensor.

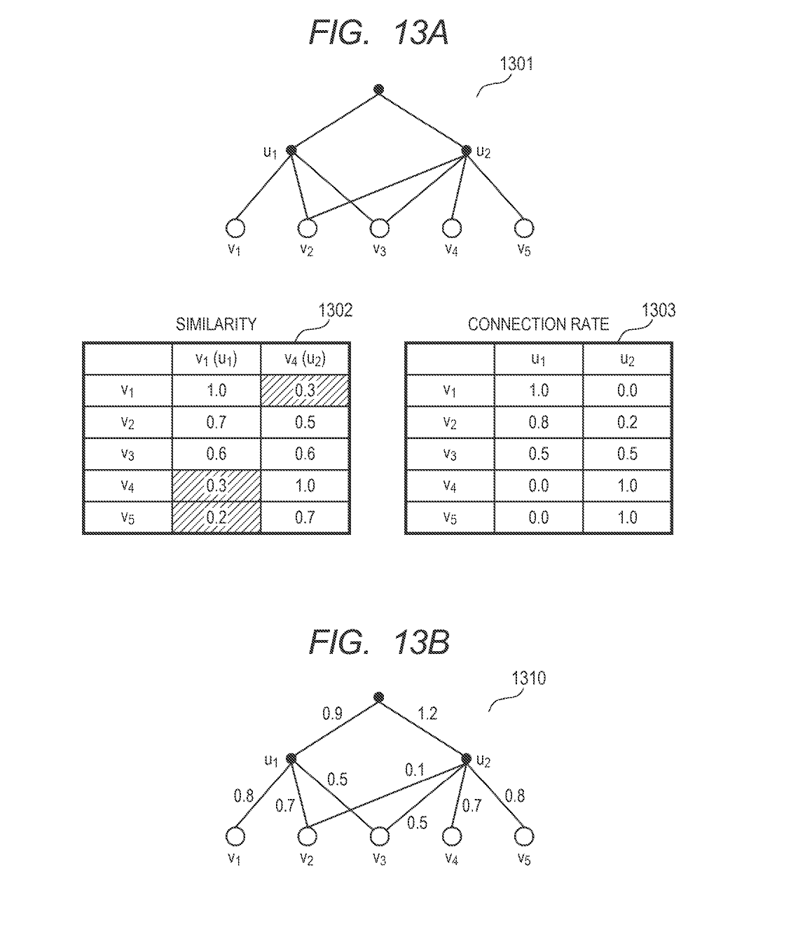

FIG. 13A shows an embodiment of a method of calculating a connection rate between a child node and a parent node. In FIG. 13A, an example in which a connection rate between nodes v₁ to v₅ on a lowermost layer and nodes u₁, u₂ on a second layer from the lowermost layer is calculated in a process for generating a graph 1301 is shown. In this example, v₁ and v₄ are set as representative nodes of u₁ and u₂. In a table 1302, similarity between v₁ to v₅ and v₁ and v₄ is shown. A correction rate with u₁ and u₂ is calculated based upon the similarity with v₁ and v₂. When the similarity is equal to or smaller than a certain threshold, no connection is made (that is, a connection rate is 0). In this example, the threshold is set to 0.3 and in the table 1302, cells having a value equal to or smaller than the threshold are shown by oblique lines. Besides, the higher the similarity is, the higher a connection rate is made to be.

A connection rate w (v, u) between v and u is calculated as in the following expression for example, however, the present invention is not limited to this.

$$\begin{matrix} [ Mathematical expression 1 ] & \\ W ( V , U ) = max [ A ( v , R ( u ) ) - {T}_{A} , 0 ] / {\sum }_{{u}^{′} ∈ {V}_{2}}^{ } max [ A ( v , R ( {u}^{′} ) ) - {T}_{A} , 0 ] & ( Mathematical expression 1 )\end{matrix}$$

A (v,v′) denotes similarity between nodes v and v′, R(u) denotes a representative node corresponding to the node u, and Vₙ denotes a set including the whole nodes on the nth layer from the lowermost layer.

The connection rate defined in the mathematical expression 1 meets the following expression as to arbitrary vεV₁.

$$\begin{matrix}[ Mathematical expression 2 ] & \\ {\sum }_{u ∈ {V}_{2}}^{ } W ( V , U ) = 1 & ( Mathematical expression 2 )\end{matrix}$$

For a child node having only one parent, a connection rate with the parent node shall be 1. An example of a connection rate acquired by calculation is shown in 1303.

Such analysis that data sources that belong to the strongly connected parent node have stronger relevance can be made by calculating the connection rate with the parent node as described above and applying harmonic analysis based upon the connection rate, and high-performance data analysis is enabled.

In the example shown in FIG. 13A, the fixed threshold is set for similarity and at the value equal to or smaller than the threshold, no connection is made, however, the threshold may be also changed every parent node or every child node. Besides, in place of setting the threshold for similarity, the number of connected parent nodes is fixed and connection may be also made in the order of higher similarity. Moreover, the number of connected parent nodes may be also changed every parent node or every child node.

FIG. 13B shows an example of a graph which does not meet the mathematical expression 2, that is, a graph which has no constraint that the sum of connection rates between each child node and a parent or parent nodes is 1. A numeric value described in the vicinity of each edge denotes a connection rate of the edge. A graph called a weighted graph and having a value for an edge can be represented by interpreting the connection rate as weight. In this embodiment, harmonic analysis utilizing the information of the weight can be applied to such a weighted hierarchical graph. In an embodiment of harmonic analysis described later, each example of a case that the mathematical expression 2 is met and a case that the mathematical expression 2 is not met is shown. In consideration of a weighted graph in which a connection rate is applied to each edge in the hierarchical graph, there is also a case that data structure can be more properly represented. In such a case, the enhancement of analysis performance can be realized by applying harmonic analysis in consideration of the connection rate of the edge.

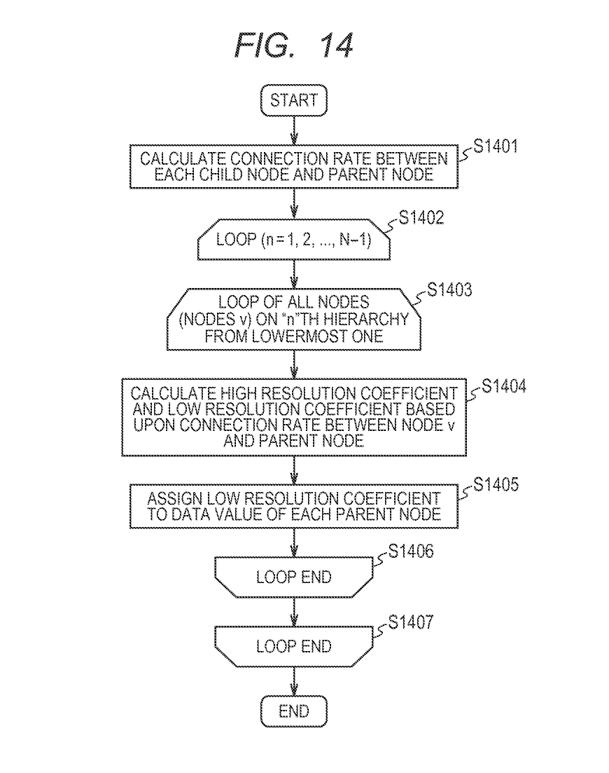

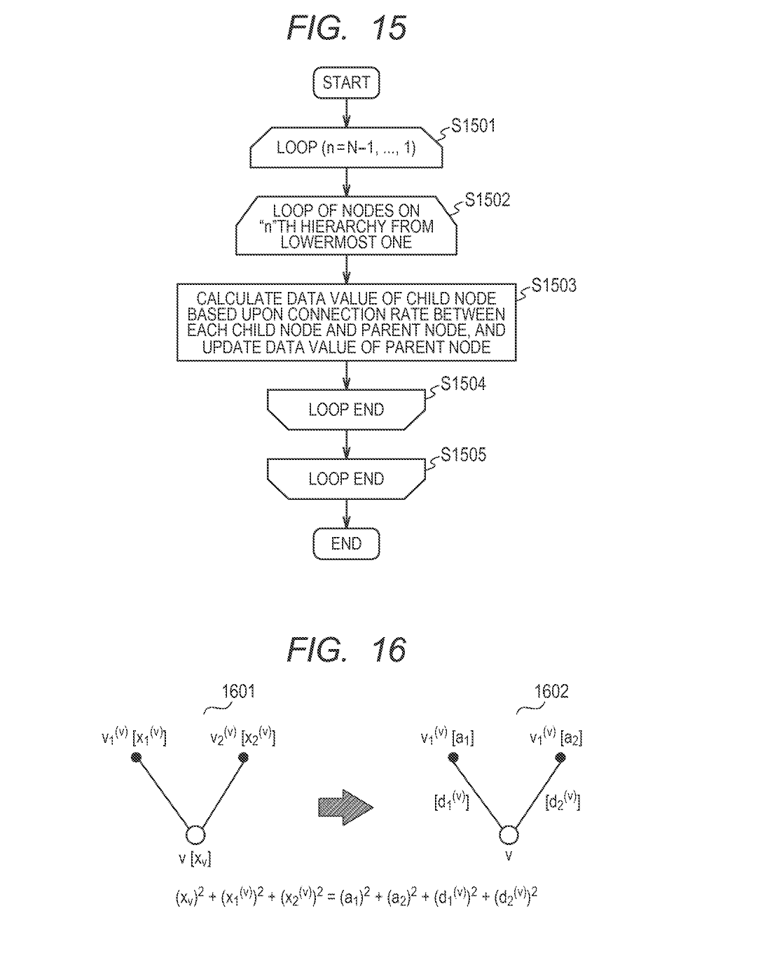

Next, a method of making multi-resolution harmonic analysis and inverse transformation of it will be described referring to FIGS. 14, 15. FIG. 14 shows a processing flow of the method of making multi-resolution harmonic analysis in one embodiment. First, in a step S1401, a correction rate between each child node and a parent node is calculated. Next, steps S1402 to S1407 are looped (N−1) times (n=1, 2, - - - , N−1). Besides, the steps S1403 to S1406 are looped for all nodes on the nth layer from a lowermost layer (object nodes shall be v). In the step S1404, a high resolution coefficient and a low resolution coefficient are calculated based upon a connection rate between the node v and its parent node. In the next step S1405, the low resolution coefficient is assigned to a data value of each parent node of the node v.

FIG. 15 shows an embodiment of a processing flow of a method of performing the inverse transformation of multi-resolution harmonic analysis. In this processing flow, the inverse processing of the flow shown in FIG. 14 is performed. First, steps S1501 to S1505 are looped (N−1) times (n=N−1, N−2, - - - , 1). Besides, the steps S1502 to S1504 are looped for all nodes on an “n”th layer from a lowermost layer (object nodes shall be v). In the step S1503, a data value of a parent node is calculated based upon a connection rate between the node v and the parent node and the data value of the parent node is updated.

Details of the steps S1404, S1405 shown in FIG. 14 and the step S1503 shown in FIG. 15 will be described below. A data value of the node v shall be xᵥ. Suppose that K pieces of parent nodes of v exist and they are represented as v₁, v₂, - - - , vₖ. Besides, their data values are represented as x₁^{(v)}, x₂^{(v)}, - - - , xₖ^{(v)}. A data value of a node having no data value, that is, a node on a layer except a lowermost layer is also calculated in harmonic analysis. The data value of the node on the layer except the lowermost layer is initialized to a proper value.

In the step S1404, high resolution transformation coefficients d₁^{(v)}, d₂^{(v)}, - - - , dₖ^{(v)} and low resolution transformation coefficients a₁, a₂, - - - , aₖ are calculated based upon the data values of each node v and its parent node as shown in the following expression.

[Mathematical expression 3]

(d₁^{(v)},d₂^{(v)}, . . . ,dₖ^{(v)},a₁,a₂, . . . ,aₖ)←f(xᵥ,x₁^{(v)},x₂^{(v)}, . . . ,xₖ^{(v)};w₁^{(v)},w₂^{(v)}, . . . ,wₖ^{(v)}) (Mathematical expression 3)

In this case, f denotes a certain function.

The f is required to be such a function to which an inverse function exists to make inverse transformation in harmonic analysis possible. “w₁^{(v)}, w₂^{(v)}, - - - , wₖ^{(v)}” are connection rates between each node v and its parent node v₁, v₂, - - - , vₖ. In the step S1405, aₖ is assigned to xₖ^{(v)} as shown in the following expression.

[Mathematical expression 4]

(xₖ^{(v)}←aₖ(kε{1,2, . . . K}) (Mathematical expression 4)

In the step S1503, calculation in the following expression is carried out as inversion transformation of (the mathematical expression 3).

[Mathematical expression 5]

(xᵥ,x₁^{(v)},x₂^{(v)}, . . . ,xₖ^{(v)})←f−1(d₁^{(v)},d₂^{(v)}, . . . ,dₖ^{(v)},x₁^{(v)},x₂^{(v)}, . . . ,xₖ^{(v)};w₁^{(v)},w₂^{(v)}, . . . ,wₖ^{(v)}) (Mathematical expression 5)

When it is considered that especially, the step S1404 is realized by such linear transformation that dₖ^{(v)} and aₖ are acquired from xᵥ, xₖ^{(v)}, wₖ^{(v)}, the mathematical expression 3 is expressed in the form of the sum of products as shown in the following expression.

[Mathematical expression 6]

dₖ^{(v)}←pₖ^{(v)}xᵥ+qₖ^{(v)}xₖ^{(v)} (Mathematical expression 6)

[Mathematical expression 7]

aₖ←p′ₖ^{(v)}xᵥ+q′ₖ^{(v)}xₖ^{(v)} (Mathematical expression 7)

“pₖ^{(v)}, qₖ^{(v)}, p′ₖ^{(v)}, q′ₖ^{(v)}” are a function of wₖ^{(v)}. The calculation in the mathematical expressions 6, 7 is carried out for 1, - - - , K as k.

A special case in the mathematical expressions 6, 7 will be shown below. In the following example, the sum of w₁^{(v)}, w₂^{(v)}, - - - , wₖ^{(v)} shall be 1.

$$\begin{matrix}[ Mathematical expression 8 ] & \\ {d}_{k}^{( v )} ← ( {x}_{k}^{( v )} - {x}_{k} ) \sqrt{\frac{{s}_{k}^{( v )} {s}_{v , k}}{{s}_{k}^{( v )} + {s}_{v , k}}} & ( Mathematical expression 8 ) \\ [ Mathematical expression 9 ] & \\ {a}_{k} ← \frac{{s}_{k}^{( v )} {x}_{k}^{( v )} + {s}_{v , k} {x}_{v}}{{s}_{k}^{( v )} + {s}_{v , k}} & ( Mathematical expression 9 )\end{matrix}$$

In this case, data values of nodes except nodes on the lowermost layer are all initialized to zero. “s_{v,k}=wₖ^{(v)}sᵥ”, and “sᵥ and s₁^{(v)}, s₂^{(v)}, - - - , sₖ^{(v)}” are values (hereinafter called mass) which the node v and its parent nodes v₁, v₂, - - - , vₖ have.

The mass of the lowermost node is 1 and the mass of nodes except the nodes on the lowermost layer is initialized to zero.

After the calculation of the mathematical expressions 8, 9 is carried out, the mass sₖ^{(v)} of the node vₖ is updated as shown in the following expression.

[Mathematical expression 10]

sₖ^{(v)}←sₖ^{(v)}+s_{v,k} (Mathematical expression 10)

It is known that the mathematical expressions 8 and 9 are a such special case as shown in the following mathematical expression 11 in the mathematical expressions 6, 7.

$$\begin{matrix}[ Mathematical expression 11 ] & \\ - {p}_{k}^{( v )} = {q}_{k}^{( v )} = \sqrt{\frac{{s}_{k}^{( v )} {s}_{v , k}}{{s}_{k}^{( v )} + {s}_{v , k}}} , \\ {p}_{k}^{′ ( v )} = \frac{{s}_{v , k}}{{s}_{k}^{( v )} + {s}_{v , k}} , \\ {q}_{k}^{′ ( v )} = \frac{{s}_{k}^{( v )}}{{s}_{k}^{( v )} + {s}_{v , k}} & ( Mathematical expression 11 )\end{matrix}$$

Inverse transformation corresponding to the harmonic analysis by the mathematical expressions 8, 9 can be realized by the following expression.

$$\begin{matrix}[ Mathematical expression 12 ] & \\ {x}_{v} ← {\sum }_{k = 1}^{K} {w}_{k}^{( v )} ( \begin{matrix}{a}_{k} - \\ {d}_{k}^{( v )} \sqrt{\frac{{s}_{k}^{( v )} {s}_{v , k}}{{s}_{k}^{( v )} + {s}_{v , k}}}\end{matrix} ) & ( Mathematical expression 12 ) \\ [ Mathematical expression 13 ] & \\ {x}_{k}^{( v )} ← {a}_{k} + {d}_{k}^{( v )} \sqrt{\frac{{s}_{v , k}}{( {s}_{k}^{( v )} + {s}_{v , k} ) {s}_{k}^{( v )}}} & ( Mathematical expression 13 )\end{matrix}$$

After the calculation of the mathematical expressions 12, 13 is carried out, the mass sₖ^{(v)} of the node vₖ is updated as shown in the following expression.

[Mathematical expression 14]

sₖ^{(v)}←sₖ^{(v)}−s_{v,k} (Mathematical expression 14)

In this embodiment, the harmonic analysis suitable for data having the graph having the hierarchical structure can be made. Tree structure is also one type of hierarchical graph structure, however, the hierarchical graph structure as an object of this embodiment is not limited to tree structure. That is, the uppermost node may be also two or more and the node except the node on the uppermost layer may also have plural parent nodes. As the hierarchical graph structure is graph structure of a wide class, various data can be exactly represented. Harmonic analysis can be applied to a graph having tree structure by processing called orthogonal transformation, however, as non-orthogonal transformation is required in a hierarchical graph which does not have tree structure, a method for the tree structure cannot be applied.

Besides, as plural parent nodes exist, harmonic analysis is required to be carried out in consideration of the strength of connection between the child node and the parent node. In this embodiment, harmonic analysis using non-orthogonal transformation is applied. Moreover, a connection rate between each child node and its parent node is calculated and a harmonic analysis method is changed according to the connection rate. In the meantime, performance and computation are compatible by making harmonic analysis utilizing information of the hierarchical structure of a graph which is not considered in a general method that can be applied to arbitrary graph structure. As for computation, high speed operation is enabled by performing multi-resolution processing for nodes on an upper layer in order from the lowermost nodes.

When graph structure is tree structure, the harmonic analysis represented in the mathematical expressions 8, 9 is processing called orthogonal transformation and the similar result to that in the transformation described in M. Gavish, B. Nadler, R. R. Coifman, International Conference on Machine Learning, pp. 367-374, 2010) is acquired. However, in the case of a hierarchical graph which is not tree structure, it is very difficult to make harmonic analysis by orthogonal transformation and it is not easy to lead the mathematical expressions 8, 9 from the method described in M. Gavish, B. Nadler, R. R. Coifman, International Conference on Machine Learning, pp. 367-374, 2010). In this embodiment, when graph structure is not tree structure, non-orthogonal transformation is applied.

Computation in the harmonic analysis and the inverse transformation is proportional to the number of nodes Nv or to “Nv×log Nv”. In harmonic analysis, as computation proportional to at least the number of nodes Nv is generally required, it can be said that computation is sufficiently a little in processing in this embodiment.

Another example in the mathematical expressions 6, 7 will be described below. In the following example, the sum of w₁^{(v)}, w₂^{(v)}, - - - , wₖ^{(v)} is not required to be 1.

$$\begin{matrix}[ Mathematical expression 15 ] & \\ {d}_{k}^{( v )} ← ( \begin{matrix}\frac{{s}_{k}^{( v )}}{{t}_{k}^{( v )}} {x}_{k}^{( v )} - \\ \frac{{s}_{v , k}}{{t}_{v , k}} {x}_{k}\end{matrix} ) \sqrt{\frac{{t}_{k}^{( v )} {t}_{v , k}}{{t}_{k}^{( v )} + {t}_{v , k}}} & ( Mathematical expression 15 ) \\ [ Mathematical expression 16 ] & \\ {a}_{k} ← \frac{{s}_{k}^{( v )} {x}_{k}^{( v )} + {s}_{v , k} {x}_{v}}{{s}_{k}^{( v )} + {s}_{v , k}} & ( Mathematical expression 16 )\end{matrix}$$

In this case, data values of nodes except nodes on the lowermost layer are all initialized to zero. “s_{v,k}=wₖ^{(v)}sᵥ” and “sᵥ and s₁^{(v)}, s₂^{(v)}, - - - , sₖ^{(v)}” are the mass of the node v and each mass of its parent nodes v₁, v₂, - - - , vₖ. The mass of the lowermost node is 1 and the mass of nodes except nodes on the lowermost layer is initialized to zero.

Besides, a mathematical expression 17 is as follows.

$$\begin{matrix}[ Mathematical expression 17 ] & \\ {t}_{v , k} = {w}_{k}^{( v )} {w}_{v} {t}_{v} , {w}_{v} = {\sum }_{k = 1}^{K} {w}_{k}^{( v )} & ( Mathematical expression 17 )\end{matrix}$$

“tᵥ” and “t₁^{(v)}, t₂^{(v)}, - - - , tₖ^{(v)}” are a value (hereinafter called second mass) which the node v has and values (second mass) which its parent nodes v₁, v₂, - - - , vₖ have. The second mass of the lowermost node is 1 and the second mass of nodes except nodes on the lowermost layer is initialized to zero.

After the calculation of the mathematical expressions 15, 16 is carried out, the mass sₖ^{(v)} of the node vₖ is updated by the mathematical expression 10. Besides, the second mass tₖ^{(v)} of the node vₖ is updated as shown in the following expression.

[Mathematical expression 18]

tₖ^{(v)}←tₖ^{(v)}+t_{v,k} (Mathematical expression 18)

Inverse transformation corresponding to the harmonic analysis by the mathematical expressions 15, 16 can be realized by the following expression.

$$\begin{matrix} [ Mathematical expression 19 ] & \\ {x}_{v} ← \frac{1}{{w}_{v} {s}_{v}} {\sum }_{k = 1}^{K} ( {a}_{k} \frac{{s}_{k}^{( v )} {t}_{v , k}}{{t}_{k}^{( v )}} - {d}_{k}^{( v )} \sqrt{\frac{( {t}_{k}^{( v )} - {t}_{v , k} ) {t}_{v , k}}{{t}_{k}^{( v )}}} ) & ( Mathematical expression 19 ) \\ [ Mathematical expression 20 ] & \\ {x}_{k}^{( v )} ← {a}_{k} \frac{{s}_{k}^{( v )} ( {t}_{k}^{( v )} - {t}_{v , k} )}{( {s}_{k}^{( v )} - {s}_{v , k} ) {t}_{k}^{( v )}} + \frac{{d}_{k}^{( v )}}{{s}_{k}^{( v )} - {s}_{v , k}} \sqrt{\frac{( {t}_{k}^{( v )} - {t}_{v , k} ) {t}_{v , k}}{{t}_{k}^{( v )}}} & ( Mathematical expression 20 )\end{matrix}$$

After the calculation of the mathematical expressions 19, 20 is carried out, the mass sₖ^{(v)} of the node vₖ is updated as shown in the mathematical expression 14 and the second mass tₖ^{(v)} is updated as shown in the following expression.

[Mathematical expression 21]

tₖ^{(v)}←tₖ^{(v)}−t_{v,k} (Mathematical expression 21)

It is clear that these examples are also the special case shown in the mathematical expressions 6, 7. When harmonic analysis is carried out in the mathematical expressions 15, 16, such a value as strongly affected by the child node having a stronger connection rate with a data value of its parent node can be acquired and harmonic analysis suitable for a weighted graph can be made.

FIG. 16 shows an example in which harmonic analysis is carried out so that the total of the sum of squares of the high resolution transformation coefficient and the sum of squares of data values of uppermost nodes is equal to the sum of squares of data values of each node before the harmonic analysis step is executed in the harmonic analysis. In this drawing, only one node v and its parent nodes are shown. In this example, for the parent nodes of the node v, two nodes v₁, v₂ are shown. A variable in brackets [ ] in the drawing denotes a data value or a transformation coefficient. The low resolution transformation coefficient is applied to the node, however, the high resolution transformation coefficient is applied not to the node but to an edge.

Graphs 1601, 1602 show states before and after the step S1404 shown in FIG. 14 is executed for the node v. In the graph 1602, the sum of squares of the high resolution transformation coefficient is (d₁^{(v)})²+(d₂^{(v)})² and the sum or squares of the low resolution transformation coefficient is (a₁)²+(a₂)². Such transformation that the total of these sums is equal to (xᵥ)²+(x₁^{(v)})²+(x₂^{(v)})² which is the sum of squares of the data values of the nodes v and v₁, v₂ in the graph 1601 is to be considered. For example, linear transformation shown in the mathematical expressions 8, 9 meets this requirement. If the processing is executed in the step S1404 so that the sum of squares of data values which are input of each node and the sum of squares of the transformation coefficients (the high resolution transformation coefficient and the low resolution transformation coefficient) which are output are equal, the total of the sum of squares of the high resolution transformation coefficient and the sum of squares of the data values of the uppermost nodes is equal to the sum of squares of the data values of each node before the harmonic analysis step is executed in the harmonic analysis shown by the flow in FIG. 14.

In each of multi-resolution processing, the sum of squares of the output (that is, the total of the sum of squares of the high resolution transformation coefficients and the sum of squares of nodes on an (n+1)th layer from a lowermost layer) is equalized to the sum of squares of the input (that is, the sum of squares of data values of nodes on an nth layer from the lowermost layer). Hereby, the sum of squares of the resolution transformation coefficients and the sum of squares of data values of the uppermost nodes which are both the output of the harmonic analysis can be equalized to the sum of squares of data values of each node which are the input of the harmonic analysis. A property that the sum of squares of data values is kept before and after the harmonic analysis is called Parseval's equality and harmonic analysis that meets this property is useful in data processing. For example, as the ratio of the sum of squares of noise included in data values which are the input and the sum of squares of components (hereinafter called signal components) except the noise is also kept after harmonic analysis, the quantity of noise can be easily estimated using values after the harmonic analysis. Besides, this property is one of important properties in the high-performance removal of noise. It is guaranteed that orthogonal transformation meets the Parseval's equality, however, non-orthogonal transformation does not generally meet this equality. However, processing that meets the Parseval's equality is also enabled in non-orthogonal transformation by performing processing for equalizing the sum of squares of the input and the sum of squares of the output in each multi-resolution processing as in this embodiment.

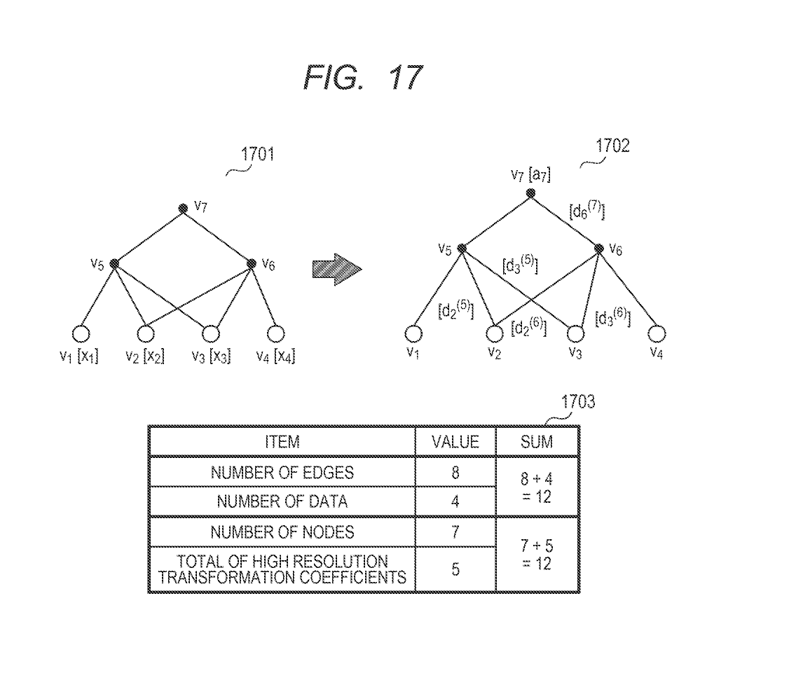

FIG. 17 shows an example that high resolution transformation coefficients of a number equal to a value acquired by subtracting the number of all nodes from the sum of the number of edges in the hierarchical graph and the number of nodes having a data value are calculated in a harmonic analysis step in one embodiment. As in FIG. 16, a variable in brackets [ ] denotes a data value or a transformation coefficient.

A graph 1701 shows an example of a hierarchical graph before harmonic analysis is carried out. Besides, a graph 1702 shows a hierarchical graph after harmonic analysis is applied to the graph 1701. A high resolution transformation coefficient for an edge that connects a node vⱼ and its parent node vₖ is represented as dⱼ^{(k)}. In the graph 1701, nodes v₅, v₆, v₇ before harmonic analysis have no data value. Therefore, when data values of the nodes v₅, v₆, v₇ are in an initialized state in calculating transformation coefficients with the nodes v₅, v₆, v₇ as a parent node in the step S1404, trivial values are calculated as high resolution transformation coefficients. In the example shown in the mathematical expression 8, as initial values of the mass of the nodes v₅, v₆, v₇ are zero, the high resolution transformation coefficients are necessarily zero. The high resolution transformation coefficients having the trivial value shall be deleted after harmonic analysis. (As such high resolution transformation coefficients include no information, they may be deleted.)

In the graph 1702, d₁⁽⁵⁾, d₄⁽⁶⁾ and d₅⁽⁷⁾ are high resolution transformation coefficients having the trivial value and they are deleted from FIG. 17. The high resolution transformation coefficient corresponding to an edge between each parent node and any of its child nodes has the trivial value. A table 1703 includes items of the number of edges, the number of data (the number of nodes having a data value, that is, in this embodiment, the number of lowermost nodes), the number of nodes and the total number of high resolution transformation coefficients respectively in the graphs 1701, 1702. As can be seen from the table 1703, the sum of the number of edges and the number of data is equal to the sum of the number of nodes and the total number of high resolution transformation coefficients.

In the case of tree structure, the number of all nodes is equal to a value acquired by adding 1 to the number of edges. Therefore, the sum of the number of high resolution transformation coefficients and the number of a data value of an uppermost node (the latter is equal to 1) which are respectively the output of harmonic analysis is equal to the number of nodes having a data value which are the input of harmonic analysis. That is, the number of output values and the number of input values are coincident. In the meantime, in this embodiment, such graph structure that each node is connected to plural parent nodes can be also represented. At this time, as described referring to FIG. 17, high-performance processing having little computation that represents hierarchical graph structure in a natural form is enabled by using such harmonic analysis that high resolution transformation coefficients of a number equal to a value acquired by subtracting the number of all nodes from the sum of the number of edges in the hierarchical graph and the number of nodes having a data value are calculated.

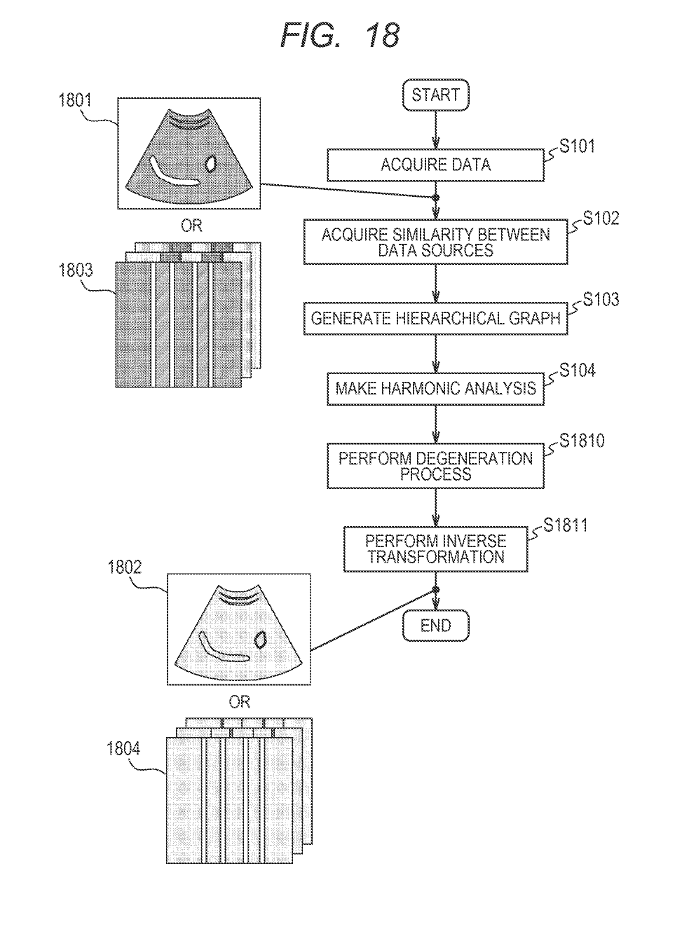

FIG. 18 shows an embodiment of a method of outputting data after the removal of noise or a method of compressing data by applying a degeneration process to the transformation coefficient after applying harmonic analysis to complex data. In FIG. 18, an example of removing noise from an image is shown, however, the present invention is not limited to this. Steps S101 to S104 are the same as the steps S101 to S104 shown in FIG. 1.

In a step S1810, a degeneration process described later is applied to the high resolution transformation coefficient calculated in the step S104. A degeneration process may be also applied not only to the high resolution transformation coefficient but to a data value of an uppermost node. Data after the removal of noise shown in an image 1802 is acquired from data before the removal of noise shown in an image 1801 by performing inverse transformation shown in a step S1811 after the degeneration process. An image may also include plural pieces as shown in 1803. In this case, one graph structure representing plural pieces of images is generated using each pixel for a data source, and harmonic analysis and a degeneration process are carried out. When the images are strongly related, a satisfactory result can be expected, compared with a case that noise is removed from each every image.

An image 1804 shows an example of the image after noise is removed from the image 1803. Besides, as the information volume of the transformation coefficients is reduced by the degeneration process and signal components can be efficiently represented by a little information volume, the similar flow can be also used for data compression.

Processing for inverse transformation shown in the step S1811 can be realized by the flow shown in FIG. 15. A method of performing a degeneration process after wavelet transformation and finally performing inverse transformation is widely known, however, high-performance noise removal processing can be performed by applying harmonic analysis to complex data as in this embodiment in place of general wavelet transformation.

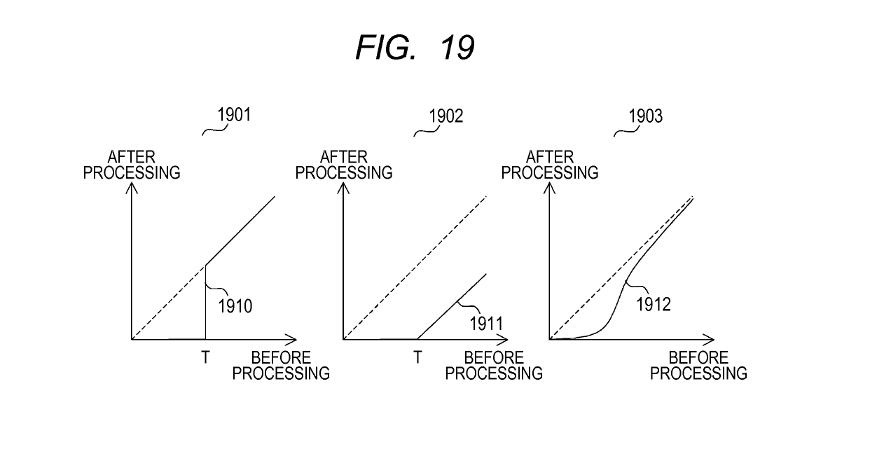

FIG. 19 shows an embodiment of a method of a degeneration process. In graphs 1901 to 1903, transformation coefficients (shall be x) before the degeneration process are shown on abscissas, the transformation coefficients (shall be y) after the degeneration process are shown on ordinates, and the transformation coefficients after the degeneration process are represented as a function of the transformation coefficients before the degeneration process. In a function 1910, when a transformation coefficient before the degeneration process is smaller than a certain threshold T, its value is transformed to zero (that is, y=0) and when it is equal to or larger than T, a transformation coefficient after the degeneration process is equalized to the transformation coefficient before the degeneration process (that is, y=x). The function 1910 has an advantage that as a shape of the function is simple, theoretical analysis of noise removal performance and others are relatively easy, however, as the function 1910 is discontinuous at the threshold T, a pseudo pattern called an artifact is apt to occur in the transformation coefficient after the degeneration process. A function 1911 makes the transformation coefficient after the degeneration process a value (y=x−T) acquired by subtracting T from the transformation coefficient before the degeneration process when the transformation coefficient before the degeneration process is equal to or larger than the threshold T so that the function 1911 is continuous at the threshold T. Further, as in a function 1912, a degeneration process may be also performed using a differentiable function.

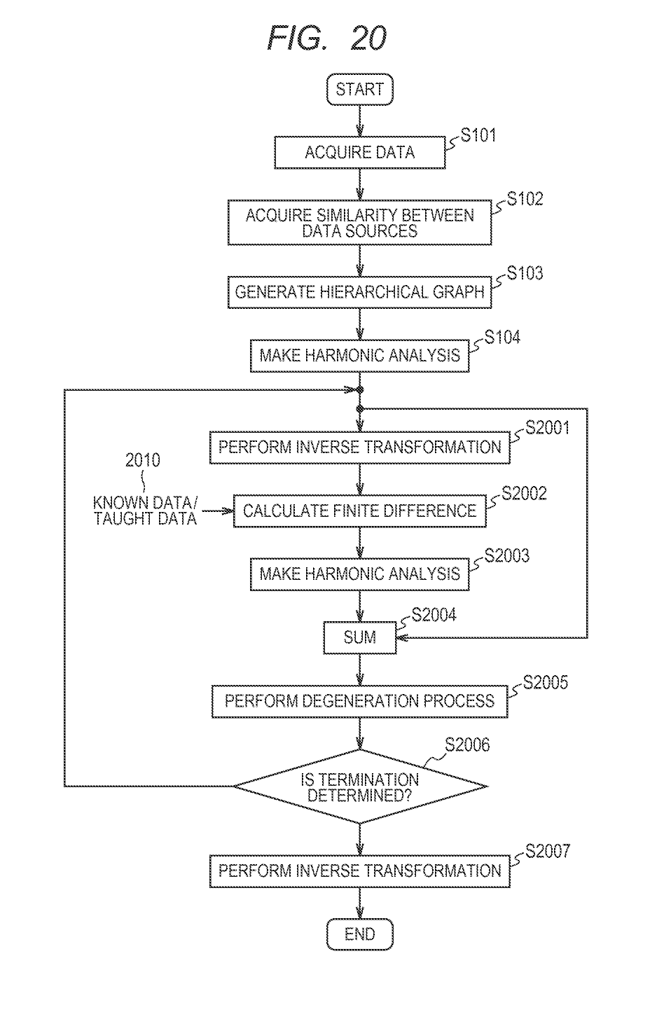

FIG. 20 shows an embodiment of a method of estimating an unknown data value in complex data by repeatedly applying harmonic analysis to the complex data. This method can be used for estimating a missing data value. And, this method can be also used for semi-teaching type data classification. The semi-teaching type data classification can be grasped as a problem of estimating a data value corresponding to untaught data as described in relation to FIG. 8.

Steps S101 to S104 are the same as the steps S101 to S104 shown in FIG. 1. After the step S104, steps S2001 to S2006 are repeatedly processed. First, in the step S2001, inverse transformation is performed. Next, in the step S2002, finite difference between a known data value and a data value acquired in the inversion transformation is calculated. At this time, finite difference when the data value is that of an unknown data source shall be zero. In the step S2003, harmonic analysis is applied to the calculated finite difference. In this harmonic analysis, the same graph structure as that generated in the harmonic analysis in the step S104 is used. In the step S2004, the sum of a transformation coefficient immediately before the inverse transformation in the step S2001 and the transformation coefficient acquired in the step S2003 is calculated. Afterward, in the step S2005, a degeneration process is performed. In the step S2006, termination is determined and the steps S2001 to S2006 are repeated until a termination condition is met. The termination condition may be also set for a repeated frequency, may be also set for the finite difference calculated in the step S2002, and may be also set for a transformation coefficient after the degeneration process in the step S2005 for example. Finally, inverse transformation is performed in the step S2007 and a result of estimating a data value of each data source is acquired.

As described above, it can be expected that performance is enhanced more than that in the conventional type method by estimating a missing data value and performing semi-teaching type data classification by the harmonic analysis using the complex data.

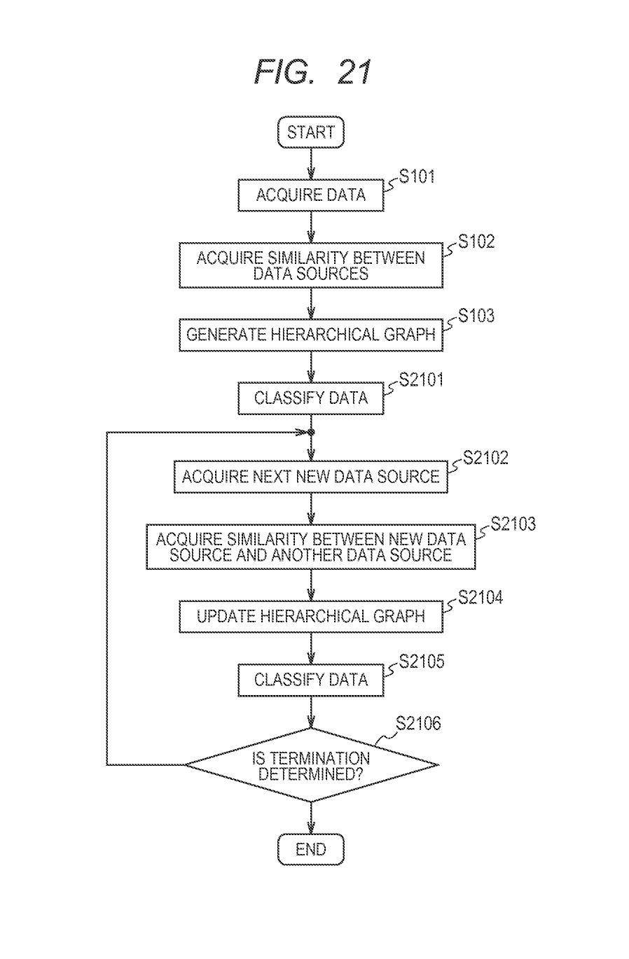

FIG. 21 shows an embodiment of a method of dynamically performing half teaching type data classification, sequentially acquiring data in place of collectively classifying data after all data are acquired. Steps S101 to S103 are the same as the steps S101 to S103 shown in FIG. 1. However, as the performance of data classification cannot be fulfilled when the number of data is too small, the step S101 is kept from proceeding until data of the number to a certain extent can be acquired.

In a step S2101, the data acquired in the step S101 is classified. Next, steps S2102 to S2106 are repeated every time when a new data source is acquired. In the step S2102, the next new data source is acquired. In the step S2103, similarity between the new data source and the other data source is acquired. In the step S2104, a hierarchical graph is updated based upon the similarity acquired in the step S2103. Concretely, a node corresponding to the new data source is added to the hierarchical graph. In the step S2105, data is classified using the updated hierarchical graph. At this time, only data of the new data source may be classified or data of the other data source may be classified again. In the step S2106, termination is determined.

As described above, as processing can be performed before all data are acquired by dynamically performing semi-teaching type data classification, high-speed classification can be performed. This embodiment is suitable for a case in which short classification time is required.

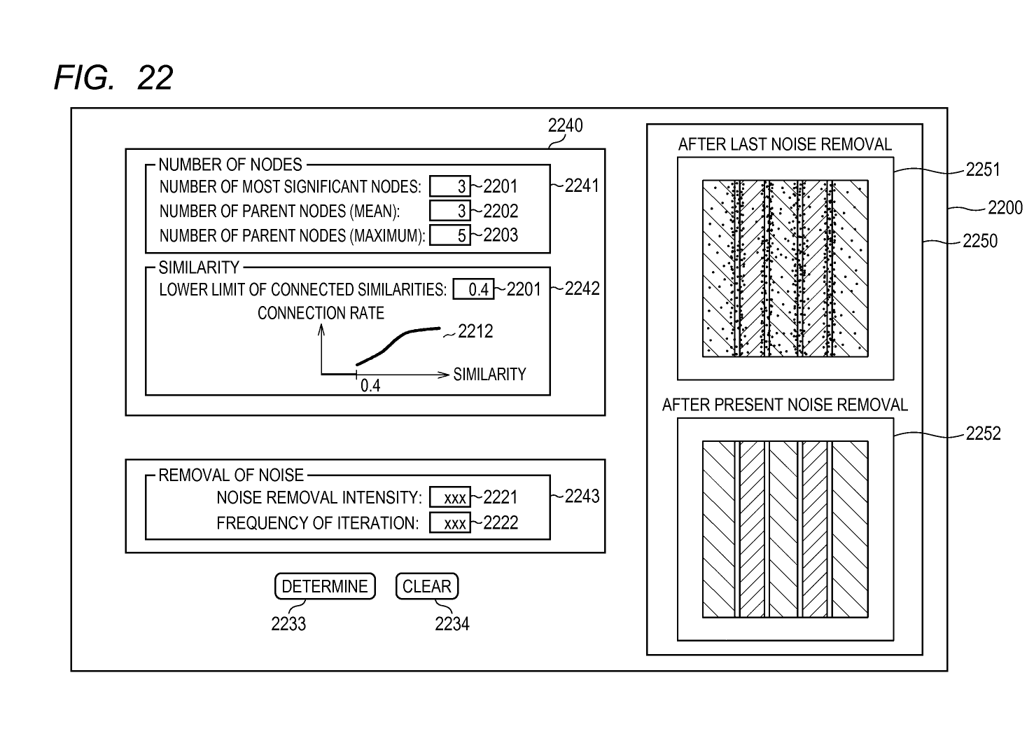

FIG. 22 shows a user interface screen 2200 when harmonic analysis is applied to complex data in one embodiment. This user interface screen 2200 is provided to the input/output unit 304. An area 2240 denotes a display area for setting parameters for generating a hierarchical graph. The area 2240 is provided with an area 2241 for setting the number of nodes in the hierarchical graph. This area has a field 2201 for setting the number of nodes on an uppermost layer and fields 2202, 2203 for respectively setting a mean value and a maximum value of the number of parent nodes which each child node has.

Besides, the area 2240 is provided with an area 2242 for setting values related to similarity. This area has a field 2211 for setting a lower limit of connected similarity. When similarity is lower than a value specified in the field 2211, it is possible to set not to connect corresponding nodes. Further, the field 2242 has a field 2212 for setting relation between similarity and a connection rate. In the field 2212, an interface that enables visually adjusting a value using a graph and an interface that directly describes a relational expression can be used. All parameters are not necessarily independent but may be mutually related. A function for interlocking parameters which are not independent and automatically updating the other values if necessary when one value is set may be also provided.

An area 2243 is an area for setting processing conditions when noise is removed after applying harmonic analysis to the graph. In the area 2243, parameters related to noise removal processing are set. This area 2243 has a field 2221 for setting noise removal intensity and a field 2222 for setting a frequency of repetition in the case of noise removal according to a method of repetition.

Moreover, a button “determine” 2233 and a button “clear” 2234 are displayed on the user interface screen 2200, harmonic analysis is applied to plural data pieces on conditions set by clicking the button “determine” 2233 when the setting of each condition is finished in the node setting area 2241, the similarity setting area 2242 and the noise removal processing condition setting area 2243, and noise removal processing is applied to the result. In the meantime, when each condition set in the node setting area 2241, the similarity setting area 2242 and the noise removal processing condition setting area 2243 is changed, the individual condition or all the conditions can be collectively erased by clicking the button clear 2243.

In addition, when the noise removal processing is not required, the processing of data is executed by clicking the decision button 2233 after each data is set in the area 2240.

An area 2250 of the user interface screen 220 is an image display area and an image after noise is removed is displayed. In an example shown in FIG. 22, in the image display area 2250, an image 2251 acquired by performing noise removal processing on conditions set in the noise removal parameter setting area 2243 last time (last time noise processed image) and an image 2252 acquired by performing noise removal processing on conditions set in the noise removal parameter setting area 2243 newly this time (this time noise processed image) are displayed alongside. Noise removal parameters set in the noise removal parameter setting area 2243 can be optimized. More proper processing can be performed by persuading a user to make settings related to the graph generation method, the harmonic analysis method and the processing after harmonic analysis via these interfaces.

The present invention made by these inventors has been concretely described based upon the embodiments, however, the present invention is not limited to the embodiments, and it need scarcely be said that various variations are allowed in a scope which does not deviate from the object.

### REFERENCE SIGNS LIST

201 . . . linear structure, 202 . . . circular structure 210 . . . image to noise removal target 220 . . . sensor network 221 . . . sensor, 301 . . . data acquisition unit, 302 . . . similarity acquisition unit, 303 . . . data base, 304 . . . input/output unit, 305 . . . control unit, 306 . . . hierarchical graph generation unit, 307 . . . connection rate calculation unit, 308 . . . harmonic analysis unit, 309 . . . data processing unit.

1. A data harmonic analysis method, comprising the steps of:
acquiring a plurality of data pieces to be analyzed;
calculating similarity between a plurality of data sources which are generation sources of respective data values of the plurality of data pieces acquired in the data acquisition step;
generating a hierarchical graph having a hierarchy of a plurality of child nodes corresponding to the plurality of data pieces as a lower layer for graph structure representing the plurality of data pieces acquired in the data acquisition step and having a layer of parent nodes having no data as an upper layer;
calculating a connection rate between each of the plurality of child nodes and its parent node using information of similarity acquired in the similarity calculation step in the hierarchical graph generated in the hierarchical graph generation step; and
analyzing data by applying harmonic analysis to the data values in the graph based upon the hierarchical graph generated in the hierarchical graph generation step,
wherein, in the analysis step, the harmonic analysis is carried out according to the connection rate calculated in the connection rate calculation step between the child node and the parent node.

2. A data harmonic analysis method, comprising the steps of:
acquiring a plurality of data pieces to be analyzed;
calculating similarity between a plurality of data sources which are generation sources of respective data values of the plurality of data pieces acquired in the data acquisition step;
specifying the number of nodes on an uppermost layer out of one or more layers including parent nodes having no data and respectively arranged on the upside of a lowermost layer as a hierarchy of a plurality of child nodes corresponding to the plurality of data pieces in graph structure representing the plurality of data pieces acquired in the data acquisition step;
generating a hierarchical graph including the lowermost layer to the uppermost layer on a condition of the number of nodes on the uppermost layer specified in the node number specification step;
inputting information of a lower limit of similarity for connecting each of the plurality of child nodes on the lowermost layer in the hierarchical graph generated in the hierarchical graph generation step and the parent node on the upper layer by one of the lowermost layer;
calculating a connection rate between each of the plurality of child nodes and the parent node using the information of the similarity acquired in the similarity calculation step and the information of the lower limit of the similarity input in the similarity lower limit information input step; and
analyzing data by applying harmonic analysis to the data values in the graph according to the connection rate calculated in the connection rate calculation step based upon the hierarchical graph generated in the hierarchical graph generation step.

3. The data harmonic analysis method according to claim 1,
wherein, in the connection rate calculation step, the higher the similarity acquired in the similarity calculation step is, the higher connection rate is set.

4. The data harmonic analysis method according to claim 1,
wherein, in the hierarchical graph generation step, a plurality of layers including parent nodes having no data are formed.

5. The data harmonic analysis method according to claim 1,
wherein, in the harmonic analysis step, data is analyzed using a value acquired based upon a connection rate between each parent node on the layer of the parent nodes and each child node on the layer of the child nodes on the downside of the layer of the parent nodes for a data value of the parent node.

6. The data harmonic analysis method according to claim 1,
wherein the plurality of layers of parent nodes having no data are formed in the hierarchical graph generation step;
the connection rate between each node on each layer of the plurality of layers of the parent nodes including the layer of the child nodes is calculated in the connection rate calculation step;
a value acquired based upon the connection rate between each parent node on the upper layer by one of the layer of the child nodes and each child node on their layer is set as a data value of the parent node in the harmonic analysis step; and
the calculation of the connection rate between each parent node on the layer of the parent nodes the data value of which is set and each parent node on the upper layer by one of the parent nodes described above is sequentially performed to the parent node on the uppermost layer of the plurality of layers.

7. A data analysis device, comprising:
a data acquisition unit that acquires a plurality of data pieces to be analyzed;
a similarity calculation unit that calculates similarity between a plurality of data sources which are generation sources of respective data values of the plurality of data pieces acquired by the data acquisition unit;
a hierarchical graph generation unit that generates a hierarchical graph having a lower layer as a layer of a plurality of child nodes corresponding to the plurality of data pieces and an upper layer as a layer of parent nodes having no data for graph structure representing the plurality of data pieces acquired by the data acquisition unit;
a connection rate calculation unit that calculates a connection rate between each of the plurality of child nodes and its parent node in the hierarchical graph generated in the hierarchical graph generation unit using information of the similarity acquired in the similarity calculation unit; and
a harmonic analysis unit that analyzes data by applying harmonic analysis to the data values in the graph based upon the hierarchical graph generated in the hierarchical graph generation unit,
wherein, in the harmonic analysis unit, the harmonic analysis is carried out according to the connection rate between the child node and the parent node calculated in the connection rate calculation unit.

8. A data analysis device, comprising:
a data acquisition unit that acquires a plurality of data pieces to be analyzed;
a similarity calculation unit that calculates similarity between a plurality of data sources which are generation sources of respective data values of the plurality of data pieces acquired by the data acquisition unit;
a node number specification unit that specifies the number of nodes on an uppermost layer of one or more layers including parent nodes having no data and arranged on the upside of a lowermost layer as a layer of a plurality of child nodes corresponding the plurality of data pieces in graph structure representing the plurality of data pieces acquired by the data acquisition unit;
a hierarchical graph generation unit that generates a hierarchical graph including the lowermost layer to the uppermost layer on a condition of the number of nodes specified by the node number specification unit on the uppermost layer;
a similarity lower limit information input unit that inputs information of a lower limit of the similarity for connecting each of the plurality of child nodes on the lowermost layer and its parent node on the upper layer by one of the lowermost layer in the hierarchical graph generated in the hierarchical graph generation unit;
a connection rate calculation unit that calculates a connection rate between each of the plurality of child nodes and its parent node using the information of the similarity calculated in the similarity calculation unit and the information of the lower limit of the similarity input from the similarity lower limit information input unit; and
a harmonic analysis unit that analyzes data by applying harmonic analysis to the data values in the graph according to the connection rate calculated in the connection rate calculation unit based upon the hierarchical graph generated in the hierarchical graph generation unit.

9. The data analysis device according to claim 7,
wherein the connection rate calculation unit sets the higher connection rate for the higher similarity calculated in the similarity calculation unit.

10. The data analysis device according to claim 7,
wherein, in the hierarchical graph generation unit, the plurality of layers of the parent nodes having no data are formed.

11. The data analysis device according to claim 7,
wherein, in the harmonic analysis unit, the data analysis is carried out using a value acquired based upon the connection rate between each parent node on the layer of the parent nodes and each child node on the layer of the child nodes on the downside of the layer of the parent nodes for a data value of the parent node.

12. The data analysis device according to claim 7,
wherein the plurality of layers of parent nodes having no data are formed in the hierarchical graph generation unit;
the connection rate between each node on each layer of the plurality of layers of the parent nodes including the layer of the child nodes is calculated in the connection rate calculation unit;
in the harmonic analysis unit, a value acquired based upon the connection rate between each parent node on the upper layer by one of the layer of the child nodes and each child node on their layer is set as a data value of the parent node; and
the calculation of the connection rate between each parent node the data value of which is set and its parent node on the upper layer by one of the layers of the parent nodes is sequentially performed up to the parent node on the uppermost layer.

13. The data harmonic analysis method according to claim 2,
wherein, in the connection rate calculation step, the higher the similarity acquired in the similarity calculation step is, the higher connection rate is set.

14. The data harmonic analysis method according to claim 2,
wherein, in the hierarchical graph generation step, a plurality of layers including parent nodes having no data are formed.

15. The data harmonic analysis method according to claim 2,
wherein, in the harmonic analysis step, data is analyzed using a value acquired based upon a connection rate between each parent node on the layer of the parent nodes and each child node on the layer of the child nodes on the downside of the layer of the parent nodes for a data value of the parent node.

16. The data harmonic analysis method according to claim 2,
wherein the plurality of layers of parent nodes having no data are formed in the hierarchical graph generation step;
the connection rate between each node on each layer of the plurality of layers of the parent nodes including the layer of the child nodes is calculated in the connection rate calculation step;
a value acquired based upon the connection rate between each parent node on the upper layer by one of the layer of the child nodes and each child node on their layer is set as a data value of the parent node in the harmonic analysis step; and
the calculation of the connection rate between each parent node on the layer of the parent nodes the data value of which is set and each parent node on the upper layer by one of the parent nodes described above is sequentially performed to the parent node on the uppermost layer of the plurality of layers.

17. The data analysis device according to claim 8,
wherein the connection rate calculation unit sets the higher connection rate for the higher similarity calculated in the similarity calculation unit.

18. The data analysis device according to claim 8,
wherein, in the hierarchical graph generation unit, the plurality of layers of the parent nodes having no data are formed.

19. The data analysis device according to claim 8,
wherein, in the harmonic analysis unit, the data analysis is carried out using a value acquired based upon the connection rate between each parent node on the layer of the parent nodes and each child node on the layer of the child nodes on the downside of the layer of the parent nodes for a data value of the parent node.

20. The data analysis device according to claim 8,
wherein the plurality of layers of parent nodes having no data are formed in the hierarchical graph generation unit;
the connection rate between each node on each layer of the plurality of layers of the parent nodes including the layer of the child nodes is calculated in the connection rate calculation unit;
in the harmonic analysis unit, a value acquired based upon the connection rate between each parent node on the upper layer by one of the layer of the child nodes and each child node on their layer is set as a data value of the parent node; and
the calculation of the connection rate between each parent node the data value of which is set and its parent node on the upper layer by one of the layers of the parent nodes is sequentially performed up to the parent node on the uppermost layer.
